(19) United States
(12) Patent Application Publication
(10) Pub. No.: US 2022/0095276 A1
(43) Pub. Date: Mar. 24, 2022

(54) SELECTION OF RADIO ACCESS TECHNOLOGIES FOR V2X MESSAGES

(71) Applicant: SHARP KABUSHIKI KAISHA, Sakai City, Osaka (JP)

(72) Inventors: TATSUSHI AIBA, Sakai City, Osaka (JP); KEN PARK, Vancouver, WA (US); JIA SHENG, Vancouver, WA (US)

(21) Appl. No.: 17/267,005

(22) PCT Filed: Aug. 8, 2019
(86) PCT No.: PCT/JP2019/031397

§ 371 Date: Feb. 8, 2021

Related U.S. Application Data
(60) Provisional application No. 62/716,304, filed on Aug. 8, 2018.

(51) Int. Cl. H04W 72/02; H04W 72/08; H04W 72/04

(52) U.S. Cl. CPC H04W 72/02; H04W 92/18; H04W 72/044; H04W 72/085

(57) ABSTRACT

A user equipment participates in vehicle-to-anything (V2X) communications. The user equipment comprises processor circuitry and a transmitter and/or receiver. The processor circuitry configured is to autonomously make a selection, from radio resources of at least two radio access technologies, of a radio resource(s) for transmission and/or reception of a V2X message of the V2X communication. The transmitter and/or receiver is configured to use the selected radio resource(s) for the transmission and/or reception of the V2X message.

### CROSS-REFERENCE TO RELATED APPLICATION(S)

This application is a national stage application of International Patent Application PCT/JP2019/031397, filed Aug. 8, 2019, now published as WO 2020/032181 A1. International Patent Application PCT/JP2019/031397 claims the benefit of U.S. Provisional Patent Application 62/716,304, filed Aug. 8, 2018. U.S. Provisional Patent Application 62/716,304 and International Patent Application PCT/JP2019/031397, now published as WO 2020/032181 A1, are incorporated herein by reference.

### TECHNICAL FIELD

The technology relates to wireless communications, and particularly to selecting radio resources for a vehicle (V2X) communications messages.

### BACKGROUND ART

When two user equipment terminals (e.g., mobile communication devices) of a cellular network or other telecommunication system communicate with each other, their data path typically goes through the operator network. The data path through the network may include base stations and/or gateways. If the devices are in close proximity with each other, their data path may be routed locally through a local base station. In general, communications between a network node such as a base station and a wireless terminal is known as “WAN” or “Cellular communication”.

It is also possible for two user equipment terminals in close proximity to each other to establish a direct link without the need to go through a base station. Telecommunications systems may use or enable device-to-device (“D2D”) communication, in which two or more user equipment terminals directly communicate with one another. In D2D communication, voice and data traffic (referred to herein as “communication signals” or “communications”) from one user equipment terminal to one or more other user equipment terminals may not be communicated through a base station or other network control device of a telecommunication system. “Device-to-device (“D2D”) communication may also be known as “sidelink direct” communication (e.g., sidelink communication), or even as “sidelink”, “SL”, or “SLD” communication.

D2D or sidelink direct communication can be used in networks implemented according to any suitable telecommunications standard. A non-limiting example of such as standard is the 3rd Generation Partnership Project (“3GPP”) Long Term Evolution (“LTE”). The 3GPP standard is a collaboration agreement that aims to define globally applicable technical specifications and technical reports for third and fourth generation wireless communication systems. The 3GPP may define specifications for next generation mobile networks, systems, and devices.

3GPP Rel-14 specified a feature that covers use cases and potential requirements for LTE support for vehicular communications services (represented by the term, Vehicle-to-Everything (V2X) Services). The feature is documented in the TR 22.885 on LTE Study on LTE Support for V2X Services. V2X services may include one or more of the following:
V2V: covering LTE-based communication between vehicles.
V2P: covering LTE-based communication between a vehicle and a device carried by an individual (e.g. handheld terminal carried by a pedestrian, cyclist, driver or passenger).
V2I: covering LTE-based communication between a vehicle and a roadside unit. A roadside unit (RSU) is a transportation infrastructure entity (e.g. an entity transmitting speed notifications).

Thus far 3GPP deliberations concerning synchronization for vehicle-to-vehicle (V2V) communications have essentially assumed reuse of LTE sidelink for V2V, e.g., assumed that the V2V communications will essentially be indistinct from sidelink direct communications in the access stratum (AS), e.g., may use the same PC5 radio access interface. As such, it has generally been assumed that the LTE 3GPP resource selection design for SLD would be reused for V2X communication as much as possible. On the other hand, there are still numerous differences between V2X and D2D, such as higher V2X user equipment (UE) density and much higher V2X UE velocity.

What is needed are methods, apparatus, and/or techniques for selecting radio resources for a V2X messages involved in vehicle (V2X) communications.

### SUMMARY OF INVENTION

In one example, a user equipment which participates in vehicle-to-anything (V2X) communications, comprising: processor circuitry configured to autonomously make a selection, from radio resources of at least two radio access technologies, of a radio resource(s) for transmission and/or reception of a V2X message of the V2X communication; a transmitter and/or receiver configured to use the selected radio resource(s) for the transmission and/or reception of the V2X message.

In one example, a method in a user equipment which participates in vehicle-to-anything (V2X) communications, comprising: using processor circuitry to autonomously make a selection, from radio resources of at least two radio access technologies, of a radio resource(s) for transmission and/or reception of a V2X message of the V2X communication; using the selected radio resource(s) for the transmission and/or reception of the V2X message.

In one example, a node of a core network comprising: processor circuitry configured to generate a set of thresholds, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication; interface circuitry configured to transmit the set of thresholds ultimately to a node of a radio access network that is in radio communication with the user equipment.

In one example, a method in a node of a core network, the method comprising: using processor circuitry to generate a set of thresholds, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication; transmitting the set of thresholds ultimately to a node of a radio access network that is in radio communication with the user equipment.

In one example, a node of a radio access network comprising: processor circuitry configured to include a set of thresholds in a message, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication; transmitter circuitry configured to transmit the message comprising the set of thresholds over a radio interface to the user equipment.

In one example, a method in node of a radio access network, the method comprising: using processor circuitry to include a set of thresholds in a message, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication; transmitting the message comprising the set of thresholds over a radio interface to the user equipment.

### BRIEF DESCRIPTION OF DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view showing generally three scenarios which may occur in vehicle (V2X) communication, i.e., an in coverage vehicle (V2X) communication scenario; a partial coverage vehicle (V2X) communication scenario; and an out-of-coverage vehicle (V2X) communication scenario.

FIG. 2 is a diagrammatic view showing that, in differing implementations, V2X communication may be implemented either in conjunction with sidelink direct (SLD) communication, in conjunction with enhanced SLD, or apart from SLD as a separate V2X communication protocol.

FIG. 3 is a schematic view of a network wherein at least one user equipment is in communication with plural radio access technologies and must select radio resources for a V2X message.

FIG. 4 is a schematic view of an example embodiment of a generic user equipment configured to make a selection of a radio resources for a V2X message.

FIG. 5A is a flowchart showing basic, representative acts or steps performed by the user equipment of FIG. 4 in selecting radio resources for a V2X message.

FIG. 5B is a flowchart showing basic, representative sub-acts or sub-steps performed by the user equipment of FIG. 4 in selecting radio resources for a V2X message.

FIG. 6A is a diagrammatic view of an example set of thresholds which may be used by the user equipment of FIG. 4 in making a selection of radio resources for a V2X message.

FIG. 6B is a diagrammatic view of an example configured threshold table comprising plural sets of thresholds which may be used by the user equipment of FIG. 4 in making a selection of radio resources for a V2X message.

FIG. 6C is a diagrammatic view of an example configured threshold table comprising plural sets of thresholds which may be used, in conjunction with plural table indices, by the user equipment of FIG. 4 in making a selection of radio resources for a V2X message.

FIG. 7A is a flowcharts depicting example, representative, basic acts or steps implemented in an example embodiment and mode of a V2X message resource selection procedure.

FIG. 7B is a flowcharts depicting example, representative, basic acts or steps implemented in an example embodiment and mode of a V2X message resource selection procedure.

FIG. 7C is a flowcharts depicting example, representative, basic acts or steps implemented in an example embodiment and mode of a V2X message resource selection procedure.

FIG. 8A is a diagrammatic view showing selection of resources for transmission and reception of a V2X message in a situation in which one table index is provided by a network and thus a composite threshold A is utilized.

FIG. 8B is a diagrammatic view showing selection of resources for transmission and reception of a V2X message in a situation in which two table indices is provided by a network and thus both composite threshold A and composite threshold B are utilized.

FIG. 9 is a schematic view of a network comprising a network node, an access node, and a user equipment wherein the user equipment implements a V2X message resource selection procedure.

FIG. 10 is a flowchart showing example, representative, acts or steps performed by a network node of FIG. 9.

FIG. 11 is a diagrammatic view of an example, non-limiting illustration of an information element SL-Cg-r1 with the addition of BSM_QoS_Table and BSM_QoS_Index_A and BSM_QoS_Index_B.

FIG. 12 is a diagrammatic view of an example, non-limiting illustration of a SIB “SIBx-NR-V2X”, e.g., a SystemInformationBlockTypeX-NR-V2X that comprises V2X sidelink communication configuration.

FIG. 13 is a diagrammatic view of an example, non-limiting illustration of a “SL-CommConfig” information element.

FIG. 14 is a diagrammatic view showing example elements comprising electronic machinery which may comprise a wireless terminal, a radio access node, and a core network node according to an example embodiment and mode.

### DESCRIPTION OF EMBODIMENTS

In one of its example aspects the technology disclosed herein concerns a user equipment which participates in vehicle-to-anything (V2X) communications and a method in the user equipment. In a generic example embodiment and mode the user equipment comprises processor circuitry and a transmitter and/or receiver. The processor circuitry configured is to autonomously make a selection, from radio resources of at least two radio access technologies, of a radio resource(s) for transmission and/or reception of a V2X message of the V2X communication. The transmitter and/or receiver is configured to use the selected radio resource(s) for the transmission and/or reception of the V2X message.

In one of its example aspects the technology disclosed herein concerns a node of a core network and a method in the node. In a generic example embodiment and mode the core network node comprises processor circuitry and interface circuitry. The processor circuitry is configured to generate a set of thresholds. The set of thresholds is configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication. The interface circuitry is configured to transmit the set of thresholds ultimately to a node of a radio access network that is in radio communication with the user equipment.

In yet another of its example aspects the technology disclosed herein concerns a node of a radio access network and a method in the node. In a generic example embodiment and mode the node comprises processor circuitry and transmitter circuitry. The processor circuitry is configured to include a set of thresholds in a message. The set of thresholds is configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication. The transmitter circuitry is configured to transmit the message comprising the set of thresholds over a radio interface to the user equipment.

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “device-to-device (“D2D″) communication” may refer to a mode of communication between or among wireless terminals that operate on a cellular network or other telecommunications system in which the communication data traffic from one wireless terminal to another wireless terminal does not pass through a centralized base station or other device in the cellular network or other telecommunications system. The “device-to-device (D2D) communication” encompasses one or both of D2D signaling (e.g., D2D control information) and D2D data. “Device-to-device (“D2D″) communication may also be known as “sidelink direct” communication (e.g., sidelink communication). The term “sidelink direct” may also be shortened to “sidelink”, abbreviated as “SL”, and as such “sidelink” may be used herein to refer to sidelink direct. Yet further, the term “ProSe” (Proximity Services) direct communication may be used in lieu of sidelink direct communication or device-to-device (D2D) communication. Therefore, it is to be understood that herein the terms “sidelink direct”, sidelink” (SL), “ProSe” and “device-to-device (D2D)” may be interchangeable and synonymous.

Thus, as mentioned above, device-to-device (D2D) or sidelink direct communication differs from “WAN” or “Cellular communication” which is or involves communication between the base station and the wireless terminal. In device-to-device (D2D) communication, communication data is sent using communication signals and can include voice communications or data communications intended for consumption by a user of a wireless terminal. Communication signals may be transmitted directly from a first wireless terminal to a second wireless terminal via D2D communication. In various aspects, all, some or none of the control signaling related to the D2D packet transmission may be managed or generated by the underlying core network or base station. In additional or alternative aspects, a receiver user equipment terminal may relay communication data traffic between a transmitter user equipment terminal and one or more additional receiver user equipment terminals.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology. Another non-limiting example of a base station is an access point. An access point may be an electronic device that provides access for wireless terminal to a data network, such as (but not limited to) a Local Area Network (“LAN”), Wide Area Network (“WAN”), the Internet, etc. Although some examples of the systems and methods disclosed herein may be described in relation to given standards (e.g., 3GPP Releases 8, 9, 10, 11, 12, 13, and thereafter), the scope of the present disclosure should not be limited in this regard. At least some aspects of the systems and methods disclosed herein may be utilized in other types of wireless communication systems.

As used herein, the term “telecommunication system” or “communications system” can refer to any network of devices used to transmit information. A non-limiting example of a telecommunication system is a cellular network or other wireless communication system.

As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMT Advanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

Vehicle (V2X) communication is described in one or more of the following (all of which are incorporated herein by reference in their entirety):

3GPP TS 36.331 V13.0.0 “Evolved Universal Terrestrial Radio Access (E-UTRA); Radio Resource Control (RRC); Protocol specification”, including but not limited to § 5.10.3 (Sidelink communication monitoring), § 5.10.4 (Sidelink communication transmission), and § 9.3.2 (pre-configurable parameters).

RP-151109, Feasibility Study on LTE-based V2X Services 3GPP TSG RAN Meeting #68, Malmö, Sweden, Jun. 15-18, 2015.

RP-152293, Support for V2V services based on LTE sidelink, 3GPP TSG RAN Meeting #70, Sitges, Spain, Dec. 7-10, 2015

3GPP TSG RAN WG1 Meeting #84bis, Busan, Korea 11th-15 Apr. 2016, Chairman notes.

3GPP TR 22.885 V14.0.0 3rd Generation Partnership Project; Technical Specification Group Services and System Aspects; Study on LTE Support for V2X Services (Release 14).

Chairman's Notes, RANI #85, Nanjing, China, May 23-May 27, 2016.

RP-161298, “LTE based V2X Services”, Busan, South Korea, Jun. 13-16, 2016.

Chairman's Notes, RANI 486, Gothenburg, Sweden, Aug. 22-26, 2016

Vehicle (V2X) communication is a communication that involves a radio connection established between a transmit device and a receive device (e.g., a wireless terminal or UE), which radio communication may or may not transit via a base station node of the network, with at least of one the transmit device and the receive device being mobile, e.g., capable of being moved. Generic V2X encompasses one or more of vehicle to infrastructure (V2I) communication; vehicle to person/pedestrian (V2P) communication; and vehicle to vehicle (V2V) communication. It is understood in the art, and intended herein, that V2X refers to both V2X and X2V; that V2I refers to both V2I and I2V; that V2P refers to both V2P and P2V; and so forth.

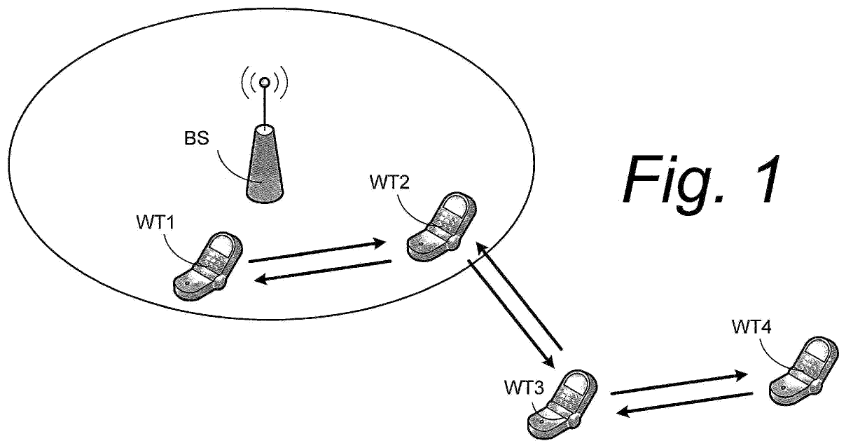

Generally, there are three general scenarios which may occur in vehicle (V2X) communication. Those three general vehicle (V2X) communications scenarios are illustrated in FIG. 1. A first vehicle (V2X) communication scenario is an “in coverage” vehicle (V2X) communication scenario, illustrated between WT1 and WT2 of FIG. 1, in which both WT1 and WT2 are within coverage of the cellular radio access network. A second vehicle (V2X) communication scenario is a “partial coverage” scenario, illustrated between WT2 and WT3 of FIG. 1. In the “partial coverage” vehicle (V2X) communication scenario the wireless terminal WT2 is within coverage of the cellular radio access network, but the wireless terminal WT3 is out-of-coverage of the cellular radio access network. A third vehicle (V2X) communication scenario is an “out-of-coverage” scenario, illustrated between wireless terminal WT3 and wireless terminal WT4 of FIG. 1. In the out-of-coverage vehicle (V2X) communication scenario both the wireless terminal WT3 and the wireless terminal WT4 are out-of-coverage of the cellular radio access network.

The three vehicle (V2X) communication scenarios are described with reference to whether or not a participating wireless terminals (e.g., WTs) are “in coverage” or “out-of-coverage” of one or more cellular radio access networks (which may collectively be referred to as a “cellular radio access network”). For sake of simplicity FIG. 1 depicts “coverage” as being with respect to an access node BS such as eNodeB which comprises a cellular radio access network. It should be understood, however, that a wireless terminal may also be in coverage of the cellular radio access network when served by any cell of the cellular radio access network(s). For example, if wireless terminal WT1 and wireless terminal WT2 were served by different cells, when participating in vehicle (V2X) communication the wireless terminal WT1 and wireless terminal WT2 would still be in an in coverage vehicle (V2X) communication scenario.

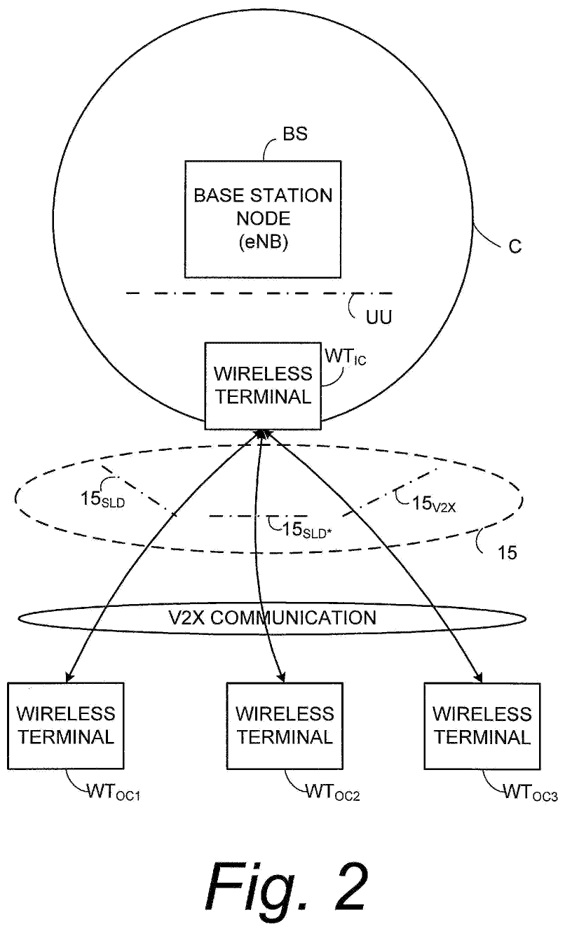

As used herein and as illustrated in FIG. 2, V2X communication may be implemented in several ways. For illustrative context, FIG. 2 illustrates a base station node BS of a cellular radio access network which serves a cell C. The base station BS may communicate with a wireless terminal WT_{IC} which is in coverage of the cellular radio access network over a radio interface UU. FIG. 2 further shows that wireless terminal WT_{IC} may engage in vehicle (V2X) communication with one or more other wireless terminals which are outside of coverage of the cellular radio access network, particularly wireless terminal WT_{OC1}, wireless terminal WT_{OC2}, and wireless terminal WT_{OC3}. It is assumed that either wireless terminal WT_{IC}, or all of wireless terminal WT_{OC1}, wireless terminal WT_{OC2}, and wireless terminal WT_{OC3} are mobile terminals for the communication to be vehicle (V2X) communication. Being “mobile” means that the wireless terminal is provided or situated in/with a mobile entity, such as a vehicle or a person.

As a first example implementation, V2X communication may be implemented using applications and resources of the type that were utilized for sidelink direct (SLD) communication (also known as device-to-device (“D2D”) communication) before introduction of vehicle (V2X) communication. For example, when implemented as part of SLD communication the V2X communication may use resources and channels of the SLD communication scheme. In such first implementation the V2X communication may be said to be implemented using pre-V2X sidelink direct (SLD) protocol and over a pre-V2X sidelink direct (SLD) radio interface 15SLD.

As a second example implementation, V2X communication may be implemented using enhanced applications and enhanced resources utilized for sidelink direct (SLD) communication, e.g., sidelink direct communications augmented or enhanced with additional capabilities to accommodate vehicle (V2X) communication. In such second implementation the V2X communication may be said to be implemented using enhanced sidelink direct (SLD) protocol and over an enhanced sidelink direct (SLD) radio interface 15SLD*.

As a third example implementation, V2X communication may operate separately from sidelink direct (SLD) communication by, e.g., having separate and dedicated V2X communication resources and channels, and by being performed using application software which is specific to V2X communication. In such third implementation the V2X communication may be said to be implemented using separate vehicle (V2X) communications protocol and over a separate vehicle (V2X) communication radio interface 15V2X.

The fact that three example implementations are illustrated in FIG. 2 does not mean that a particular wireless terminal has to participate in all three or even two of the example implementations. FIG. 2 simply indicates the expansive meaning of the term vehicle (V2X) communication and that the technology disclosed herein encompasses vehicle (V2X) communication in all of its various existing and potential implementations.

In sidelink direct communications, a scheduling assignment (SA) is used to indicate the data radio resources that may be used to carry data in a sidelink direct transmission, e.g., to a receiving wireless terminal. As such, there may be one or more pools of scheduling assignment (SA) radio resources that are used to carry the scheduling assignment (SA) information, with the scheduling assignment (SA) resources being different than the data radio resources that are described by the scheduling assignment (SA). The data radio resources typically belong to a data pool (of data radio resources).

Any reference to a “resource” herein means “radio resource” unless otherwise clear from the context that another meaning is intended. In general, as used herein a radio resource (“resource”) is a time-frequency unit that can carry information across a radio interface, e.g., either signal information or data information. An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element (RE) is the smallest time-frequency unit for downlink transmission in the subframe. That is, one symbol on one sub-carrier in the sub-frame comprises a resource element (RE) which is uniquely defined by an index pair (k,l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in case of normal cyclic prefix.

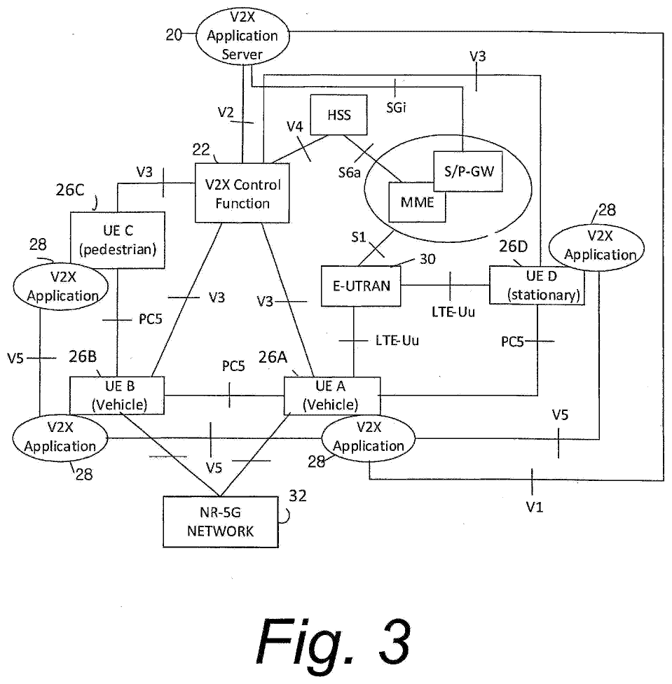

One aspect of the technology disclosed herein is a wireless terminal which autonomously makes a selection, from radio resources of at least two radio access technologies, of a radio resource(s) for transmission and/or reception of a message of the V2X communication, e.g., a V2X message. FIG. 3 shows network architecture wherein V2X services are available through V2X application server 20 and V2X control function 22 to plural user equipment units (UEs) 26A, 26B, 26C, and 26D. The V2X application server 20 is connected to V2X control function 22 over interface V2, the V2X control function 22 is connected to the UEs 26 over interface V3. Of the shown user equipment units, UE 26A and UE 26B are vehicle user equipment units, UE 26C is a pedestrian user equipment, and UE 26D is a stationary user equipment. The plural user equipment units (UEs) 26A, 26B, 26C, and 26D may communicate with each other over a PC5 interface.

Each UE 26 capable of V2X service has an associated V2X application 28 which executes, e.g., on processor circuitry of the UE 26. The V2X applications 28 of the various user equipment units 26 may communicate with one another over a V5 interface, and with the V2X application server 20 over a V1 interface.

The user equipment units 26 shown in FIG. 3 communicate with at least one core network of a first radio access technology type, and may also communicate with a network of a second radio access technology type. For example, UE 26A and UE 26D are shown in FIG. 3 as communicating over a radio interface LTE-Uu with E-UTRAN network 30 which represents a first type radio access technology (Long Term Evolution). Although not shown as such, other user equipment units of FIG. 3 may also communicate with E-UTRAN network 30. The E-UTRAN network 30 is shown as being connected over interface S1 to, e.g., a mobility management unit (MME), and the MME in turn being connected over interface S6a to Home Subscriber Server (HSS). The Home Subscriber Server (HSS) is connected by interface V4 to V2X control function 22.

In addition, UE 26A and UE 26B are shown as communicating over a radio interface NR-Uu with New Radio 5G network 32. The interface NR-Uu corresponds to the Uu interface for LTE but with protocol for NR rather than LTE. Although not shown as such in FIG. 3, the NR core network may comprise nodes comparable in functionality to the MME and HSS as shown for the LTE network.

The V2X application server 20, V2X control function 22, V2X applications 28, V1-V5 interfaces, and various reference points illustrated in FIG. 3 are described in 3GPP TS 23.285, v15.1.0 2018-06-19, which is incorporated herein by reference in its entirety. Among the reference points are those listed in Table 1 below.

TABLE 1

| | |
|---|---|
| V2: | The reference point between the V2X Application Server |
| | and the V2X Control Function in the operator's network. The |
| | V2X Application Server may connect to V2X Control |
| | Functions belonging to multiple PLMNs. |
| V3: | The reference point between the UE and the V2X Control |
| | Function in UE's home PLMN. It is based on the service |
| | authorization and provisioning part of the PC3 reference |
| | point defined in clause 5.2 of TS 23.303. It is applicable to |
| | both PC5 and LTE-Uu based V2X communication and |
| | optionally MBMS and LTE-Uu based V2X communication. |
| V4: | The reference point between the HSS and the V2X Control |
| | Function in the operator's network. |
| V6: | The reference point between the V2X Control Function in |
| | the HPLMN and the V2X Control Function in the VPLMN. |
| PC5: | The reference point between the UEs used for user plane for |
| | ProSe Direct Communication for V2X Service. |
| S6a: | In addition to the relevant functions defined in TS 23.401 for |
| | S6a, in case of V2X Service S6a is used to download V2X |
| | Service related subscription information to MME during |
| | E-UTRAN attach procedure or to inform MME subscription |
| | information in the HSS has changed. |
| S1-MME: | In addition to the relevant functions defined in TS 23.401 for |
| | S1-MME, in case of V2X Service it is also used to convey |
| | the V2X Service authorization from MME to eNodeB. |
| xMB: | The reference point between the V2X Application Server |
| | (e.g. Content Provider) and the BM-SC, and defined in |
| | TS 26.346. |
| MB2: | The reference point between the V2X Application Server |
| | and the BM-SC, and defined in TS 23.468 [7]. |
| SGmb/ | The SGmb/SGi-mb/M1/M3 reference points are internal to |
| SGi-mb/ | the MBMS system and are defined in TS 23.246. |
| M1/M3: | |
| LTE-Uu: | The reference point between the UE and the E-UTRAN. |

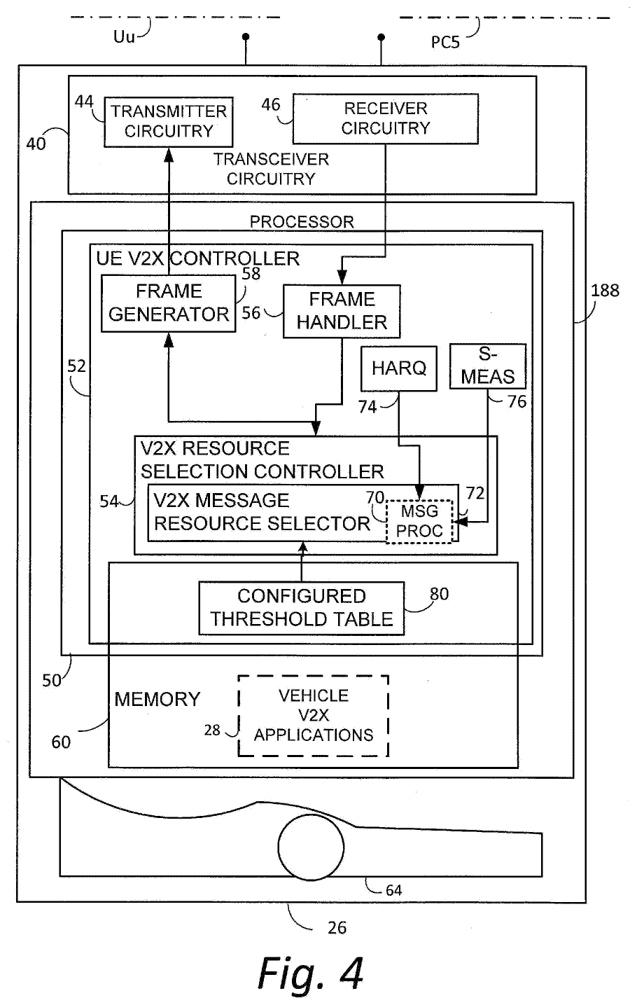

FIG. 4 shows various example, representative, non-limiting components and functionalities herein pertinent of a generic wireless terminal or vehicle UE 26, such as UE 26A or UE 26B of FIG. 3. The wireless terminal 26 comprises transceiver circuitry 40, which in turn comprises transmitter circuitry 44 and receiver circuitry 46. The transceiver circuitry 40 includes antenna(e) for the wireless terminal 26. Transmitter circuitry 44 includes, e.g., amplifier(s), modulation circuitry and other conventional transmission equipment. Receiver circuitry 46 comprises, e.g., amplifiers, demodulation circuitry, and other conventional receiver equipment. The transceiver circuitry 40 is configured to use resources for communication with a radio access network, such as E-UTRAN network 30 and/or New Radio 5G network 32, as well as resources allocated for V2X communication, whether those resources be shared with sidelink direct (SLD) communications or separate and distinct for V2X communication as previously described.

The user equipment 26 further comprises processor circuitry, also herein known more simply as UE processor 50, or simply as processor 50. While processor 50 may have responsibility for operation of many aspects of wireless terminal 26 not specifically described herein, in one of its aspects processor 50 serves as UE V2X controller 52 for controlling aspects of vehicle (V2X) communication. As further illustrated in FIG. 4, the UE V2X may comprise V2X resource selection controller 54. The UE V2X controller 52 may also comprise, or work in conjunction with frame handler 56 and frame generator 58. In the particular example implementation shown in FIG. 4, the frame handler 56 and frame generator 58 are shown as comprising the UE processor 50 for handling frame operations with respect to transmissions with the radio access network in addition to the V2X transmissions.

In addition to UE processor circuitry 50, wireless terminal 26 also comprises UE memory 60, e.g., memory circuitry, which may store an operating system and various application programs, such as vehicle V2X communication application 28. The memory 60 may be any suitable type of memory, e.g., random access memory (RAM), read only memory (ROM), cache memory, processor register memory, or any combination of one or more memory types. The applications such as V2X application 28 comprises instructions executable by processor circuitry 50 and are stored in non-transient portions of memory 60. At least some aspects of UE memory 64 may also be considered as part of UE V2X controller 52.

The user equipment 26 further comprises UE user interface(s) 64. The user interfaces 64 may comprise one or more suitable input/output devices which are operable by a user. Some of all of the user interfaces 64 may be realized by a touch sensitive screen. The user interface(s) 64 may also comprise a keyboard, audio input and output, and other user I/O devices. Only a portion of the user interfaces 64 is depicted in FIG. 4, it being understood that the user interfaces 64 may be provided on a cover or case of UE 26 and thus may visibly obscure the underlying other components shown in FIG. 4.

The user equipment 26 participates in vehicle-to-anything (V2X) communications, meaning that the user equipment 26 may participate in one or more of vehicle to infrastructure (V2I) communication; vehicle to person/pedestrian (V2P) communication; and vehicle to vehicle (V2V) communication. FIG. 4 represents the fact that user equipment 26 participates in vehicle-to-anything (V2X) communications by showing the PC5 interface through which the user equipment 26 may engage in V2X communication with another user equipment 26. As also shown in FIG. 4, user equipment 26 also engages in communication across a Uu-type radio interface with a radio access network, such as E-UTRAN network 30 or New Radio 5G network 32. The UE transceiver circuitry 40 may be involved in both the radio access network communications over interface Uu and the V2X communications over the PC5 interface. But for the different types of communications, e.g., communications with a radio access network and V2X communications, different radio resources are utilized. For example, a sub-set of the radio resources of the radio access network, e.g., one or more “pools” of the radio access network radio resources, may be allocated to the V2X communications, e.g., for 3GPP V2X services.

3GPP V2X services will be used to transport SAE J2735 BSM (Basic Safety Message). The BSM has two parts: Part 1 of the BSM (Basic Safety Message) includes the core data elements, e.g., vehicle size, position, speed, heading acceleration, brake system status, and is transmitted approximately 10× per second. BSM (Basic Safety Message) Part 2 includes a variable set of data elements drawn from many optional data elements, and is transmitted less frequently then part 1. The BSM is expected to have a transmission range of 1,000 meters, and is tailored for localized broadcast required by V2V safety applications.

In Rel-14 LTE V2X (aka LTE V2X), a basic set of requirements for V2X service in TR 22.885 is supported, which are considered sufficient for basic road safety service. An LTE V2X enabled vehicle, e.g., a vehicle configured with a UE the supports V2X applications, may directly exchange status information via the PC5 interface. The PC5 interface may also be known as sidelink at the physical layer. The status information exchanged, e.g., via the PC5 interface, may include position, speed and heading, and may be exchanged with other nearby vehicles, infrastructure nodes and/or pedestrians that are also enabled with LTE V2X. However, the LTE V2X transport service is broadcast only, thus no HARQ feedback is transmitted by the receiving UE. There is HARQ packet combining process at the receiving LTE V2X UE. Thus, in order to increase probability of correct demodulation, the LTE V2X retransmits its user data, e.g. a PSSCH, three times in consecutive subframes, and its control data, e.g. a PSCCH, twice in different subframes, using always QPSK modulation.

In 3GPP Release 16, e.g., Rel-16, the 3GPP Fifth Generation 5G New Radio, NR, is expected to provide for enhanced V2X service, also known as NR V2X, which includes a data transport services with much lower latency and much higher throughput. See, for example, the SA1 Study on Improvement of V2X Service Handling for Rel-16, also known as FS_V2XIMP or Release 16 (Open)Specification: 22.886—Study on enhancement of 3GPP support for 5G V2X services Version: 15.1.0: Specification. Therefore, a HARQ feedback process is expected to be enabled between the transmitting NR V2X UE and the receiving NR V2X UE, which are using NR V2X resources.

Both the LTE V2X service and NR V2X service will be capable of transporting the BSM (Basic Safety Message) over the legacy PC5 based LTE V2X communication channel. In this regard, TSG RAN has agreed in TR 38.913 that NR V2X not replace the services offered by LTE V2X. Instead, the NR V2X shall complement LTE V2X for advanced V2X services and support interworking with LTE V2X. Thus, given the enhancements expected for NR V2X service, and the agreement that NR V2X service will provide a super set of the services provided by LTE V2X service, there will be deployments of the following:
NR V2X and LTE V2X where an NR V2X LTE can to send a BSM to a LTE V2X UE using LTE type resources, e.g. LTE numerology, LTE SCS, e.g., 15 kHz, LTE frequency, e.g., LTE frequency band).
NR V2X and NR V2X where an NR V2X UE can to send a BSM to a NR V2X UE using LTE type resources, e.g. LTE numerology, LTE SCS, e.g., 15 kHz, LTE frequency, e.g., LTE frequency band.
NR V2X and NR V2X where an NR V2X UE can to send a BSM to a NR V2X UE using both NR and LTE type resources, e.g. LTE/NR numerology, LTE/NR SCS, e.g., 15 kHz, 30 kHz, 60 kHz, 120 kHz, and/or 240 kHz, LTE/NR frequency, e.g., LTE/NR frequency band.

Returning now to FIG. 4, the UE processor 50 is configured to autonomously make a selection, from radio resources of at least two radio access technologies, of a radio resources) for transmission and/or reception of a V2X message. A non-limiting example of such a V2X message may be a V2X basic safety message, BSM, such as that discussed above. The technology disclosed herein encompasses all appropriate V2X messages. Other non-limiting examples of V2X messages to which the technology disclosed herein pertains may include one or more of the following:

At the V2X application layer:
Common Awareness Messages (CAM)
Decentralized Environmental Notification Messages (DENM)
Traffic signal phase and timing (SPaT)

At the PC5 control plane, messages in the class of:
SBCCH-SL-BCH-Message-V2X-r14

In sending a V2X message, the UE processor 50 may execute V2X message resource selection procedure 70 to determine if the V2X message is to be transported between 3GPP V2X services using radio resources of a first radio access technology or radio resources of a second radio access technology. A portion of the UE processor 50 known as the UE V2X controller 52, and particularly a V2X message resource selector 72, may perform the V2X message resource selection procedure 70. For example, in an example scenario in which the two radio access technologies include LTE and NR, the V2X message resource selector 72 executes a resource selection procedure 70 to determine if the BSM is to be transported between 3GPP V2X services using NR type resources or LTE type resources or both NR and LTE type resources. The user equipment 26 of FIG. 4 further comprises the transmitter 44 and/or receiver 46 which is configured to use the selected radio resource(s) for the transmission and/or reception of the V2X message.

The LTE specification TS23.285 specified a “V2X Control Function” as the logical function used for network related actions required for V2X, and that the V2X Control Function is used to provision the UE with necessary parameters that enable the UE to use V2X communication. The UE V2X controller 52 performs similar functions as specified in TS23.285 for UE 26, but the UE V2X controller 52 further serves as a NR V2X Control Function with the V2X message resource selector 72 making a determination if the V2X message (e.g., Basic Safety Message, for example) is to be transported using NR resources, or LTE resources, or both NR and LTE type services and resources.

The UE V2X controller 52, serving as a NR V2X Control Function, may enable or provide the NR V2X UE 26 with parameters for using NR or LTE or both NR and LTE transmission resources, and may provide an additional set of parameters related to QoS, or radio propagation conditions. The V2X message resource selector 72 is thereby enabled to make an autonomous determination of which resources, enabled by the UE V2X controller 52, to use for the transport of the V2X message. In other words, the UE is enabled to make an autonomous determination of which resources to use based on its current local radio frequency, RF, and traffic conditions.

In one of its example aspects, the technology disclosed herein includes the UE 26 making a determination of which resource to use (NR or LTE or both NR and LTE) to transport the V2X message over the PC5-based V2X communication channel, per the parameters provided by UE V2X controller 52, and a Hybrid Automatic Repeat Request, HARQ, function between the NR UE transmitting V2X data on PC5 and the NR UE receiving the V2X data on PC5, and S-Measurement taken on the E-UTRA carrier frequency used for PC5. The UE 26 of FIG. 4 is thus shown as further comprising both HARQ functionality 74 and signal measurement functionality 76. In an example implementation shown in FIG. 4, HARQ functionality 74 and signal measurement functionality 76 comprise UE processor 50, since these units may be involved in operations concerning transmissions with the radio access network as well as V2X HARQ and signal measurement functions.

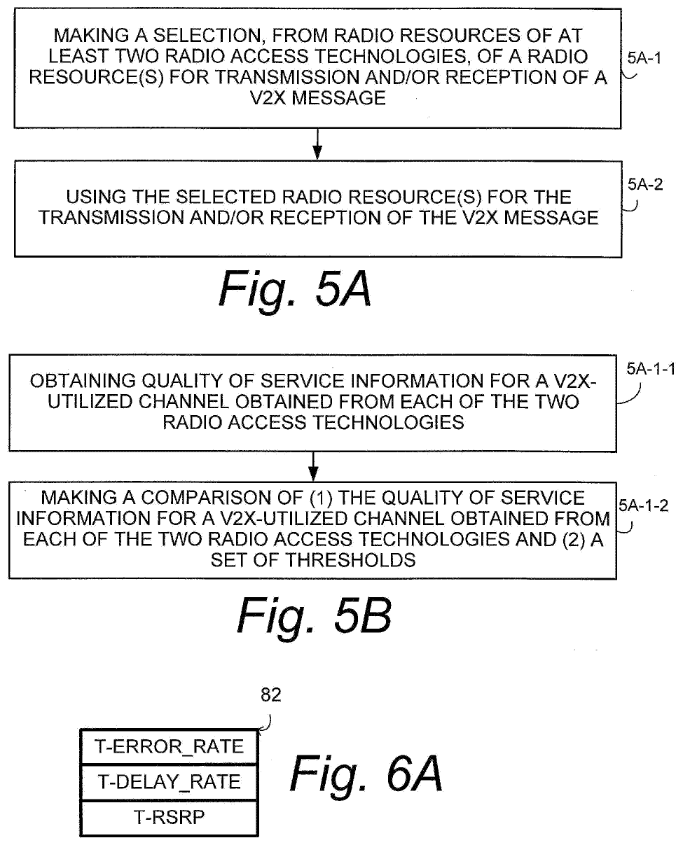

FIG. 5A shows basic, representative acts or steps performed by the user equipment 26 of FIG. 4. Act 5A-1 comprises UE processor 50 autonomously making a selection, from radio resources of at least two radio access technologies, of a radio resource(s) for transmission and/or reception of a V2X message. Act 5A-2 comprises using the selected radio resource(s) for the transmission and/or reception of the V2X message. For example, either the transmitter circuitry 44 may transmit, or the receiver circuitry 46 may receive, the V2X message using the selected radio resource(s).

In an example embodiment and mode, the UE processor 50, and V2X message resource selector 72 in particular, is configured to make the selection of radio resources for the V2X message, e.g., to perform act 5A-1 of FIG. 5A, by obtaining quality of service, e.g., QoS, information for a V2X-utilized channel obtained from each of the two radio access technologies, and then making a comparison of (1) quality of service, e.g., QoS, information for a V2X-utilized channel obtained from each of the two radio access technologies and (2) a set of thresholds. FIG. 5B thus shows basic acts or steps including act 5A-1-1 and 5A-1-2. Act 5A-1-1 comprises obtaining quality of service information for a V2X-utilized channel obtained from each of the two radio access technologies. Act 5A-1-2 comprises making a comparison of (1) the quality of service information for a V2X-utilized channel obtained from each of the two radio access technologies, e.g., the QoS information obtained at act 5A-1-1, and (2) a set of thresholds.

As explained herein, the quality of service, e.g., QoS, information for a V2X-utilized channel may be obtained from the HARQ functionality 74 and the signal measurement functionality 76. The set of thresholds comprises a respective threshold for the quality of service information obtained from each of the two radio access technologies. To this end, FIG. 4 shows the V2X message resource selector 72 as having access to configured threshold table 80 storing threshold information. For example scenarios described herein in which the V2X message is typified as a Basic Safety Message (BSM), the configured threshold table 80 may also be referred to as “BSM_QoS_Table”. From configured table 80 the V2X message resource selector 72 determines or obtains at least one particular set(s) of thresholds to be used for the comparison with the QoS information.

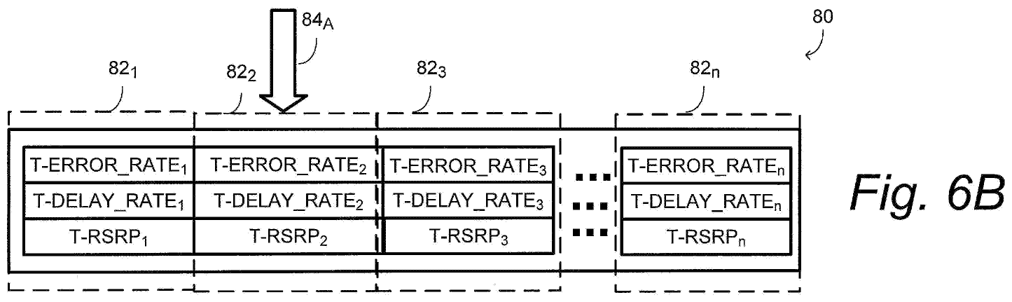

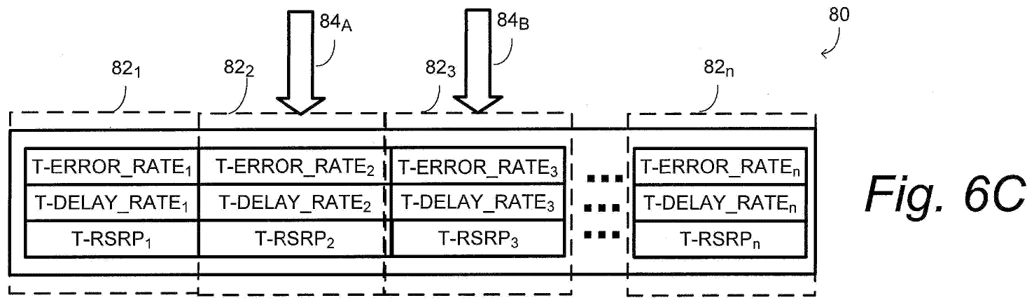

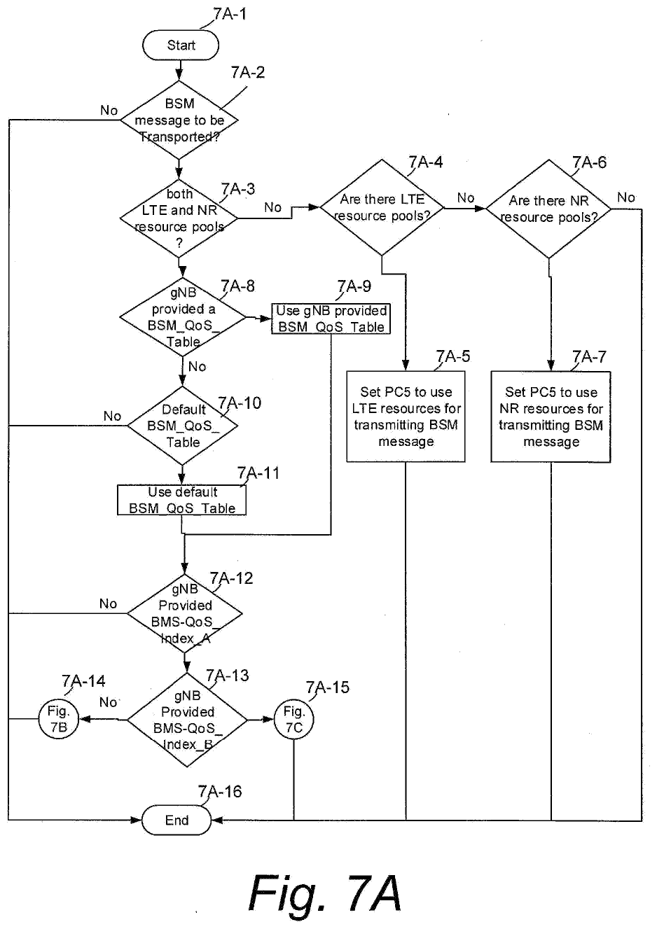

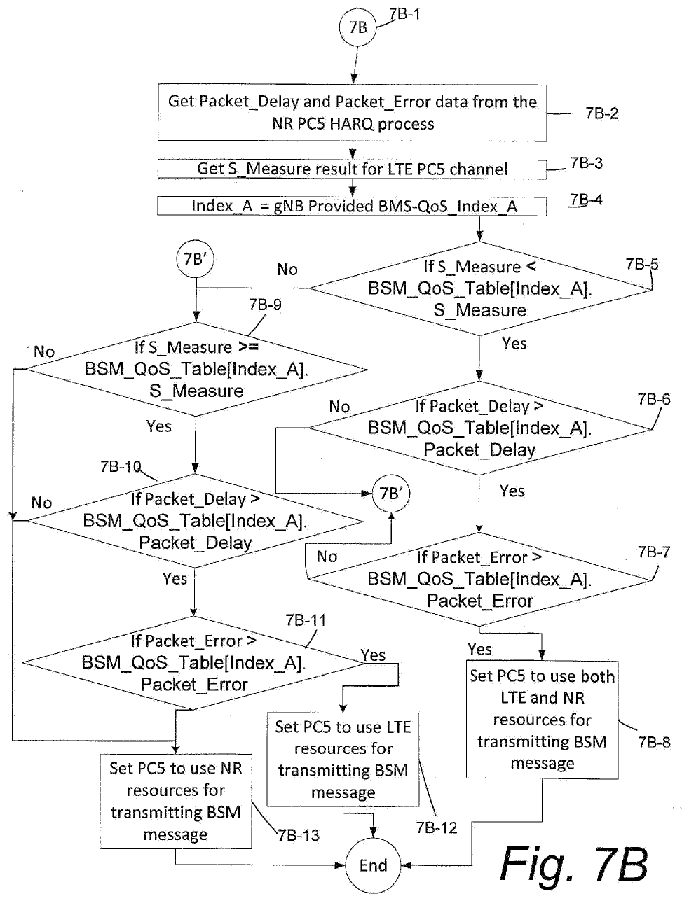

In an example embodiment and mode, for a first radio access technology the quality of service information may comprise error rate and delay rate for the V2X-utilized channel, and for a second radio access technology the quality of service information may comprise a received signal measurement for the V2X-utilized channel. In such example embodiment and mode, and as shown in FIG. 6A, a set of thresholds 82 may comprise at least a triology of values: a threshold for error rate for the V2X-utilized channel, e.g., T-error_rate; a threshold for delay rate for the V2X-utilized channel, e.g., T-delay_rate; and, a threshold for the received signal measurement for the V2X-utilized channel, e.g., T-RSRP. Although the received signal measurement is represented as reference signal received power, RSRP, any other measure of signal strength or quality may be utilized, such as, for example, reference signal received quality, RSRQ. In an example, non-limiting implementation of this example embodiment and mode, the first radio access technology may be New Radio (NR) 5G, wherein for the comparison with the thresholds the error rate and delay rate for the first radio access technology are reported by HARQ functionality 74, and the second radio access technology may be Long Term Evolution (LTE) wherein the signal measurement is reported by signal measurement functionality 76, and the V2X-utilized channel is a Sidelink PC5 channel.

In an example embodiment and mode, illustrated in FIG. 6B, the configured threshold table 80 may comprise plural sets of thresholds. In the FIG. 6B example implementation, the configured threshold table 80 may be a two-dimensional matrix with each column of the matrix corresponding to a set of thresholds, e.g., set 82₁, set 82₂, and so forth to set 82ₙ. In the FIG. 6B implementation, the V2X message resource selector 72 utilizes at least one particular set of thresholds to be used for the comparison with the QoS information. The particular set of thresholds 82 that the V2X message resource selector 72 is to obtain from the configured threshold table 80 is indicated to the V2X message resource selector 72 by an “index” value, also known as a “table index”. For example, FIG. 6B shows by index arrow 84_{A} that a table index specifies that the second column of configured threshold table 80, e.g., a second set of thresholds, is to be utilized for the comparison.

As explained herein, the V2X message resource selector 72 may make more than one comparison, and accordingly more than one column of the configured threshold table 80 may be used by V2X message resource selector 72 for obtaining more than one set of thresholds 82. Accordingly, FIG. 6B shows plural index arrows, e.g., index arrow 84_{A} and index arrow 84_{B}, which are represent or point to two set of thresholds 82, e.g., set of thresholds 82₂ and set of thresholds 82₃, respectively, which are utilized in the V2X message resource selection procedure 70.

In view of the fact that each set of thresholds 82 comprises plural thresholds, e.g., a threshold for error rate, a threshold for delay rate, and a threshold for RSRP, for example, each set may be viewed as representing or providing a composite threshold which is essentially the union or superposition of all thresholds of the set. For example, in pointing to the second column of FIG. 6B, the index arrow 84_{A} essentially designates a composite threshold A, which is the union of the three separate thresholds T-ERROR_RATE₂, T-DELAY_RATE₂, and T-RSRP₂. Such composite threshold A is herein also referred to more simply as “threshold A”. Likewise, in pointing to the third column of FIG. 6B, the index arrow 84_{B} essentially designates a composite threshold B, which is the union of the three separate thresholds T-ERROR_RATE₃, T-DELAY_RATE, and T-RSRP₃. Such composite threshold B is herein also referred to more simply as “threshold B”. It should be understood that the index arrows 84 may point to other columns of configured threshold table 80 in other scenarios and at other times.

The configured threshold table 80 may either be pre-configured at the user equipment 26 or configured by a network. Being “pre-configured” means that the configured threshold table 80 may be loaded into the UE memory 60 at time of manufacture, initial startup, or refurbishment of user equipment 26. Being “configured by a network” means that the configured threshold table 80 is transmitted to the user equipment 26 by a network using, e.g., techniques and/or messages and/or system information blocks, SIBs, as herein described.

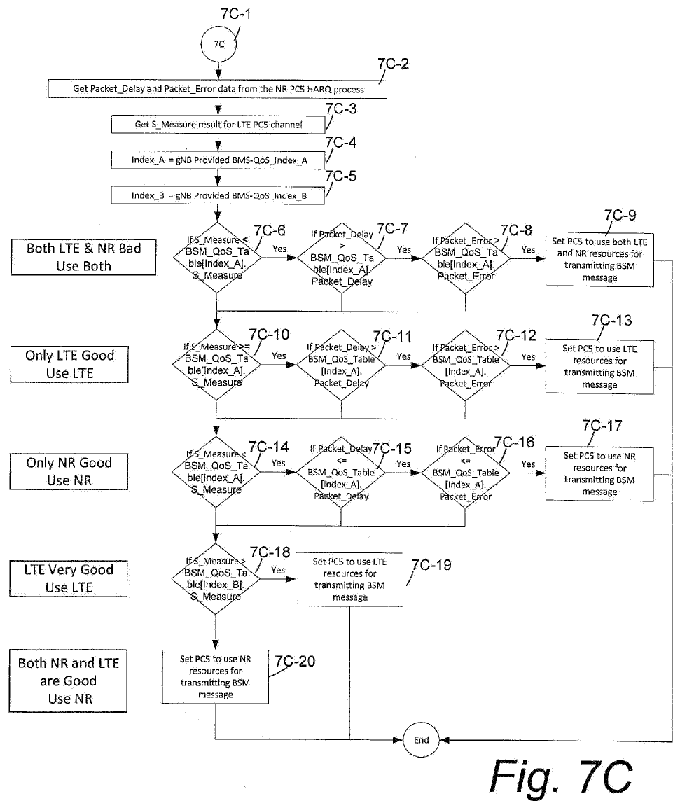

FIG. 7A describes an example, non-limiting, embodiment and mode of an instance of a V2X message resource selection procedure 70. For sake of discussion, in each of FIG. 7A, FIG. 7B, and FIG. 7C, it is presumed that, by way of non-limiting example, an instance of the V2X message resource selection procedure 70 is executed for the purpose of selecting resources for a V2X basic safety message (BSM). Certain aspects of a V2X basic safety message (BSM) have been described above. It should be understood that the example of a BSM (Basic Safety Message) is illustrated in FIG. 7A, FIG. 7B, and FIG. 7C just to represent or typify the selection of resources of any appropriate V2X message, e.g., any type of V2X message. Thus the technology disclosed herein, although encompassing the BSM (Basic Safety Message), is not limited thereto. Moreover, the instance of the V2X message resource selection procedure 70 is described herein by way of example as using New Radio as a first radio technology type and LTE as a second radio technology type. It should be understood that these radio technology types are merely illustrative and representative, and that in other embodiments and modes one or more other radio technologies may be utilized instead.

The beginning of the V2X message resource selection procedure 70 is indicated by act 7A-1. As act 7A-2, the V2X message resource selection procedure 70 checks if a BSM (Basic Safety Message) is to be transported. As mentioned above, for sake of representative example FIG. 7A, FIG. 7B, and FIG. 7C describe the handling of a BSM (Basic Safety Message) as one type of V2X message that is handled by the V2X message resource selection procedure 70. If a BSM (Basic Safety Message) is not to be sent, the instance of the V2X message resource selection procedure 70 is terminated at act 7A-16. But if a BSM (Basic Safety Message) is to be sent, the V2X message resource selection procedure 70 checks at act 7A-3 whether both LTE and NR resource pools are available to be utilized, if justified by the conditions imposed on V2X message resource selection procedure 70. If both LTE and NR resource pools are not available, V2X message resource selection procedure 70 continues its execution at act 7A-4. In other words, if only one of LTE resource pools and NR resource pools are available, but not both, execution continues it at act 7A-4.

As act 7A-4 the V2X message resource selection procedure 70 determines whether LTE resource pools are available. If it is determined at act 7A-4 that LTE resource pools are available, as act 7A-5 the V2X message resource selection procedure 70 specifies that LTE resources are to be used for transmitting the BSM (Basic Safety Message). Thereafter, as indicated by act 5A-2 of FIG. 5A, the BSM (Basic Safety Message) is transmitted by transmitter circuitry 44, after which the instance of the V2X message resource selection procedure 70 terminates at act 7A-16.

If it is determined at act 7A-4 that LTE resource pools are not available, then as act 7A-6 the V2X message resource selection procedure 70 confirms that NR resource pools are available. If act 7A-6 confirms that NR resource pools are available, as act 7A-7 the V2X message resource selection procedure 70 specifies that NR resources are to be used for transmitting the BSM (Basic Safety Message). Thereafter, as indicated by act 5A-2 of FIG. 5A, the BSM (Basic Safety Message) is transmitted by transmitter circuitry 44, after which the instance of the V2X message resource selection procedure 70 terminates at act 7A-16.

Should be determined at act 7A-3 that both LTE resource pools and NR resource pools are available, as act 7A-8 the V2X message resource selection procedure 70 checks if the network, e.g., a gNB node, has provided a configured threshold table 80. As indicated in FIG. 7A, FIG. 7B, and FIG. 7C and explained above, when dealing with the example of a BSM (Basic Safety Message) as the representative V2X message, the configured threshold table 80 may also be referred to as “BSM_QoS_Table”. If the configured threshold table 80 has been provided by the network, as act 7A-9 the V2X message resource selection procedure 70 uses the network-provided configured threshold table 80, e.g., the network-provided “BSM_QoS_Table” and thereafter continues execution at act 7A-12. On the other hand, if a configured threshold table 80 has not been provided by the network, as act 7A-10 the V2X message resource selection procedure 70 checks to determine if a default configured threshold table 80, e.g., a “BSM_QoS_Table” exists, e.g., has been preconfigured at user equipment 26. If there is no default configured threshold table 80, execution ends at act 7A-16. But if the default configured threshold table 80 does exist, as act 7A-11 the V2X message resource selection procedure 70 uses a default configured threshold table 80, and thereafter continues execution at act 7A-12.

As act 7A-12 the V2X message resource selection procedure 70 determines whether the network has provided at least one table index, such as index arrow 84_{A} shown in FIG. 6B. If no table index has been provided by the network, this instance of V2X message resource selection procedure 70 terminates at act 7A-16. If at least one table index has been provided by the network, as act 7A-13 the V2X message resource selection procedure 70 checks whether two table indices have in fact been provided by the network. The situation of two table indices being provided has been illustrated by way of example in FIG. 6C, in which both index arrow 84_{A} and index arrow 84_{B} are provided. If it turns out that just one table index has been provided, the acts of FIG. 7B are performed as represented by act 7A-14. On the other hand, if two table indices have been provided, the acts of FIG. 7C are performed as represented by act 7A-15.

FIG. 7B shows acts performed in a situation in which only one table index is provided. The one table index, represented by index arrow 84_{A} of FIG. 6B, is provided for accessing a set of thresholds 82, e.g., a first composite threshold A, from the configured threshold table 80. The routine of FIG. 7B begins at act 7B-1, after which, as act 7B-2, the V2X message resource selection procedure 70 obtains the packet delay and packet error date from the NR PC5 channel HARQ process, e.g., from HARQ functionality 74. Then, as act 7B-3, the V2X message resource selection procedure 70 obtains the signal measurement, e.g., S_measure, for the LTE PC5 channel, e.g., from signal measurement functionality 76. As indicated above, the S_measure may be, for example, referenced signal received power (RSRP). Then, as act 7B-4, the V2X message resource selection procedure 70 sets a parameter Index_A to the table index which was obtained from the network (as determined at act 7A-12).

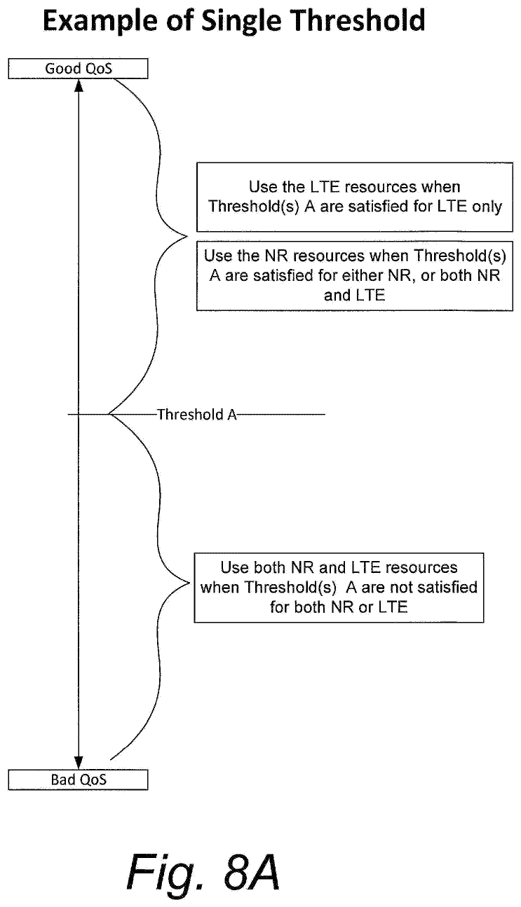

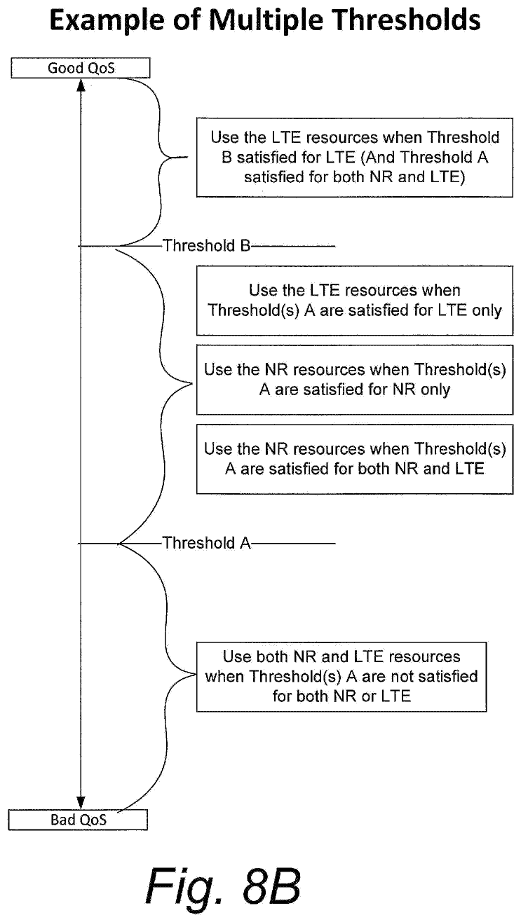

FIG. 8A illustrates the use of a single table index, e.g., Index_A, in the manner of FIG. 7B. FIG. 8A shows that (1) only LTE resources are utilized for the V2X message when threshold A is satisfied for LTE only; (2) both LTE and NR resources are utilized for the V2X message when the threshold A is satisfied for either (a) NR or (b) both NR and LTE; and (3) both NR resources and LTE resources are utilized for the V2X message when the threshold A is not satisfied for both LTE and NR. It should be remembered that the threshold A is a consolidated threshold, that represents each of plural QoS parameters satisfying their respective thresholds as specified in the set of thresholds 82 specified in the configured threshold table 80 by the index arrow 84.

FIG. 7B shows the V2X message resource selection procedure 70 as act 7B-5 checking to determine if the signal measurement is less than the respective indexed-indicated threshold RSRP; as act 7B-6 checking to determine if the HARQ-reported delay rate, Packet_Delay, exceeds the respective indexed-indicated threshold T-DELAY_RATE, and as act 7B-7 checking to determine if the HARQ-reported error rate, Packet Error, exceeds the respective indexed-indicated threshold T-ERROR_RATE. If the determinations of act 7B-5, 7B-6, and 7B-7 are all affirmative, then the composite threshold A is not satisfied for both LTE and NR. Accordingly, as shown in FIG. 8A, with quality of service not exceeding the threshold A, both NR and LTE resources are utilized for transmitting the V2X message over the PC5 interface, as also shown by act 7B-8.

On the other hand, if the determinations of any of act 7B-5, 7B-6, and 7B-7 are negative then act 7B-9 is next executed (as indicated by symbol 7B′). FIG. 7B shows the V2X message resource selection procedure 70 as act 7B-9 checking to determine if the signal measurement equals or exceeds the respective indexed-indicated threshold RSRP; as act 7B-10 checking to determine if the HARQ-reported delay rate, Packet_Delay, exceeds the respective indexed-indicated threshold T-DELAY_RATE, and as act 7B-11 checking to determine if the HARQ-reported error rate, Packet Error, exceeds the respective indexed-indicated threshold T-ERROR_RATE. If the determinations of act 7B-9, 7B-10, and 7B-11 are all affirmative, then the composite threshold A is satisfied, so that as act 7B-12 LTE resources are used for transmitting the BSM (Basic Safety Message) over the PC5 interface. On the other hand, if any of the determinations of act 7B-9, 7B-10, and 7B-11 are negative, then as act 7B-13 NR resources are used for transmitting the BSM (Basic Safety Message) over the PC5 interface. After the transmission of the BSM (Basic Safety Message), which is also shown act 5A-2, this instance of V2X message resource selection procedure 70 terminates as indicated by act 7A-16.

FIG. 7C shows acts performed in a situation in which two table indices are provided. The two table indices, represented by index arrow 84_{A} and by index arrow 84_{B} of FIG. 6C, are provided for accessing two sets of thresholds 82, e.g., a first composite threshold A and a second composite threshold B, from the configured threshold table 80. The routine of FIG. 7C begins at act 7C-1, after which, as act 7C-2, the V2X message resource selection procedure 70 obtains the packet delay and packet error date from the NR PC5 channel HARQ process, e.g., from HARQ functionality 74. Then, as act 7C-3, the V2X message resource selection procedure 70 obtains the signal measurement, e.g., S_measure, for the LTE PC5 channel, e.g., from signal measurement functionality 76. As indicated above, the S_measure may be, for example, referenced signal received power (RSRP). Then, as act 7C-4, the V2X message resource selection procedure 70 sets a parameter Index_A to the first table index which was obtained from the network, and as act 7C-5 sets a parameter Index_B to the second table index which was obtained from the network.

FIG. 8B illustrates the use of two table indices, e.g., Index_A and Index B, in the manner of FIG. 7C. FIG. 8B shows that only LTE resources are utilized when the quality of service is above the composite threshold B and composite threshold A is satisfied for both NR and, the composite threshold B being indicated by the index arrow 84_{B} and Index B. FIG. 8B further shows that both NR resources and LTE resources are utilized for the V2X message when the quality of service, QoS, is below the threshold A for both NR and LTE. FIG. 8B further shows, in the region between composite threshold A and composite threshold B, that: (1) LTE resources are used when composite threshold A is satisfied for LTE only; (2) NR resources are used when composite threshold A is satisfied for NR only; and, (3) NR resources are used when composite threshold A is satisfied for LTE only. It should be remember that both the threshold A and the threshold B are composite thresholds: that threshold A represents plural QoS parameters satisfying their respective thresholds as specified in the set of thresholds 82 specified in the configured threshold table 80 by the index arrow 84_{A}; and that threshold B represents plural QoS parameters satisfying their respective thresholds as specified in the set of thresholds 82 specified in the configured threshold table 80 by the index arrow 84_{B}.

FIG. 7C shows the V2X message resource selection procedure 70 as act 7C-6 checking to determine if the signal measurement is less than the respective indexed-indicated threshold RSRP pointed to by Index A; as act 7C-7 checking to determine if the HARQ-reported delay rate, Packet_Delay, exceeds the respective indexed-indicated threshold T-DELAY_RATE pointed to by Index A, and as act 7C-8 checking to determine if the HARQ-reported error rate, Packet_Error, exceeds the respective indexed-indicated threshold T-ERROR_RATE pointed to by Index A. If the determinations of act 7C-6, 7C-7, and 7C-8 are all affirmative, then the composite threshold A is not satisfied for both LTE and NR. Accordingly, as shown in FIG. 8A, with quality of service not exceeding the threshold A, both NR and LTE resources are utilized for transmitting the V2X message over the PC5 interface, as also shown by act 7C-9.

On the other hand, if the determinations of any of act 7C-6, 7C-7, and 7C-8 are negative then act 7C-10 is next executed. FIG. 7C shows the V2X message resource selection procedure 70 as act 7C-10 checking to determine if the signal measurement equals or exceeds the respective indexed-indicated threshold RSRP pointed to by Index A; as act 7C-11 checking to determine if the HARQ-reported delay rate, Packet_Delay, exceeds the respective indexed-indicated threshold T-DELAY_RATE pointed to by Index A, and as act 7C-12 checking to determine if the HARQ-reported error rate, Packet Error, exceeds the respective indexed-indicated threshold T-ERROR_RATE pointed to by Index A. If the determinations of act 7C-10, 7C-11, and 7C-12 are all affirmative, then as act 7C-13 LTE resources are used for transmitting the BSM (Basic Safety Message) over the PC5 interface.

On the other hand, if any of the determinations of act 7C-10, 7C-11, and 7C-12 are negative, then act 7C-14 is next performed. FIG. 7C shows the V2X message resource selection procedure 70 as act 7C-14 checking to determine if the signal measurement is less than the respective indexed-indicated threshold RSRP pointed to by Index A; as act 7C-15 checking to determine if the HARQ-reported delay rate, Packet_Delay, equals or is less than the respective indexed-indicated threshold T-DELAY_RATE pointed to by Index A, and as act 7C-16 checking to determine if the HARQ-reported error rate, Packet Error, equals or is less than the respective indexed-indicated threshold T-ERROR_RATE pointed to by Index A. If the determinations of act 7C-14, 7C-15, and 7C-16 are all affirmative, then as act 7C-17 NR resources are used for transmitting the BSM (Basic Safety Message) over the PC5 interface.

If any of the determinations of act 7C-14, 7C-15, and 7C-16 are negative, then act 7C-18 is next performed. FIG. 7C shows the V2X message resource selection procedure 70 as act 7C-18 checking to determine if the signal measurement is greater than the respective indexed-indicated threshold RSRP pointed to by Index B. If the determination of act 7C-18 is affirmative, then as act 7C-19 LTE resources are used for transmitting the BSM (Basic Safety Message) over the PC5 interface. On the other hand, if the determination of act 7C-18 is negative, then as act 7C-20 NR resources are used for transmitting the BSM (Basic Safety Message) over the PC5 interface.

It was mentioned above that the configured threshold table 80 may be “configured by a network”, e.g., transmitted to the user equipment 26 by a network. As described herein, the configured threshold table 80 may be transmitted to the user equipment 26 by a network using a unicast message or a broadcast message. A non-limiting example of a unicast message which transmits the configured threshold table 80 may be an RRC_Reconfiguration message, for example. A non-limiting example of a broadcast message which transmits the configured threshold table 80 may be system information block, SIB. These and other example messages and techniques for transmitting and receiving the configured threshold table 80 are described herein.

In an example embodiment and mode, the user equipment 26 may, at different times, receive the configured threshold table 80 in different ways, e.g., by different types of messages. For example, the user equipment 26 may at an earlier time receive a first version of a configured threshold table 80 in a broadcast message, and thereafter receive another or section version of the configured threshold table 80 in a unicast message. In such situation, regardless of when the configured threshold tables were generated, the version received in a unicast message is prioritized over a version received in a broadcast message. That is, the version received in the unicast message is used instead of the version received in the broadcast message. However, should yet another version of the configured threshold table 80 be later obtained by a broadcast message from a new macrocell, the version of the configured threshold table 80 received from the new macrocell via the broadcast message has priority and therefore will be utilized.

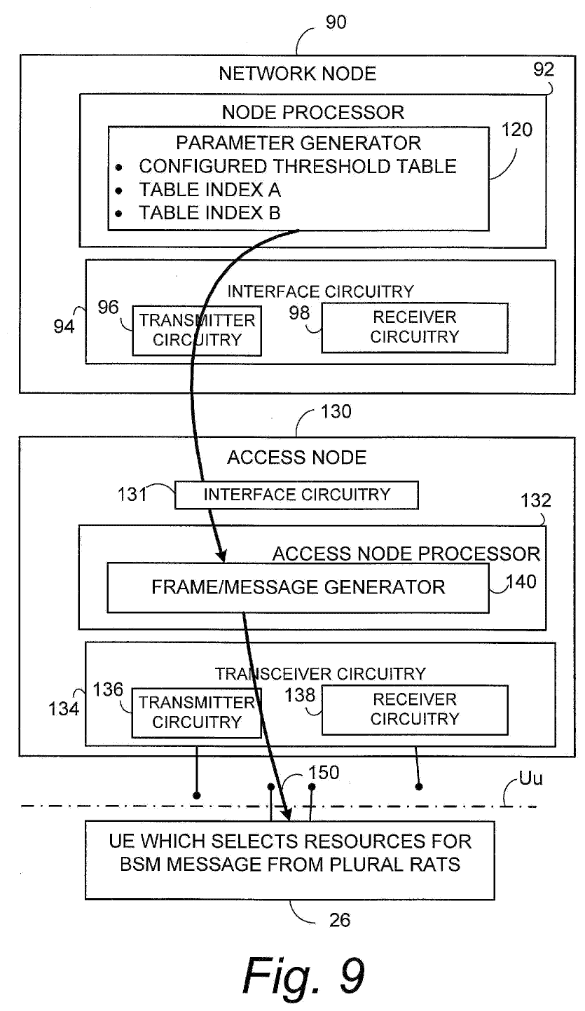

FIG. 9 illustrates an example, representative, generic network node 90 which generates and/or transmits information to enable user equipment 26 to select resources, from at least radio access technologies, for a V2X message. The network node 90 comprises both node processor circuitry 92 and node interface circuitry 94. The node interface circuitry 94 may comprise node transmitter circuitry 96 and node receiver circuitry 98 for communication with other nodes and/or ultimately or immediately with user equipment 26.

FIG. 9 further shows node processor circuitry 92 as comprising parameter generator 120. The parameter generator 120 may generate one or more different types of parameters or information for transmission to the user equipment 26 in conjunction with the user equipment 26 selecting resources, from plural radio access technology types, for use in transmitting or receiving a V2X message. Examples of the parameters that may be generated by the parameter generator 120 include the configured threshold table 80 which may transmitted to the user equipment 26, and one or more table indices, such as the Index A (see FIG. 6B, FIG. 7B, and FIG. 8A) and the Index B (see FIG. 6C, FIG. 7C, and FIG. 8B). Optionally, the parameters generated by parameter generator 120 may include an indication of pools of radio resources from which the radio resource(s) for transmission and/or reception of the V2X message of the V2X communication may be selected. As explained below, the parameter(s) generated by parameter generator 120 may be transmitted to the user equipment 26 in one or more different types of messages, such as a unicast message or a broadcast message.

It should be understood that in some example embodiments and modes the parameter(s) generated by parameter generator 120 of network node 90 may actually be transmitted to user equipment 26 through the intermediary of a radio access network node, such as access node 130 shown in FIG. 9. The access node 130 may be a base station node, such as an eNodeB (e.g., eNB) or gNB, for example, or another wireless terminal. The node 130 comprises an interface 131 for communicating with the network node 90, access node processor circuitry 132, and access node transceiver circuitry 134. The access node transceiver circuitry 134 in turn comprises access node transmitter circuitry 136 and access node receiver circuitry 138. The access node processor circuitry 132 comprises access node frame/message generator 140. The access node 130 receives the parameters generated by parameter generator 120 through interface 131, and conveys same to the access node frame/message generator 140. The access node frame/message generator 140 generates the message, illustrated as message 150, that is transmitted by access node transmitter circuitry 136, for conveying to user equipment 26 the parameters that are utilized by the V2X message resource selection procedure 70, e.g., one or both of the configured threshold table 80 and the table index(ices).

Thus, concerning the configured threshold table 80, the network node 90 comprises parameter generator 120 which may generate, e.g., a set of thresholds. As understood from the preceding discussion, the set of thresholds may be configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication. The node interface circuitry 94 of network node 90 transmits the set of thresholds ultimately to a node of a radio access network, such as access node 130, which is radio communication with the user equipment.

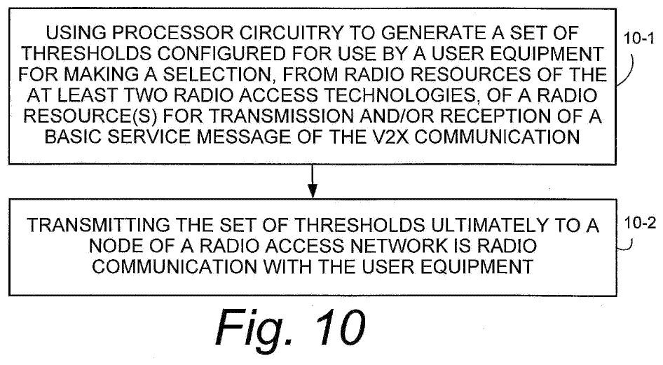

FIG. 10 illustrates example, representative, basic acts or steps performed by the network node 90 of FIG. 9. Act 10-1 comprises using processor circuitry to generate a set of thresholds. As previously explained, the set of thresholds are configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication. Act 10-2 comprises transmitting the set of thresholds ultimately to a node of a radio access network that is in radio communication with the user equipment.

One example, non-limiting role of access node 130 is thus to include the set of thresholds acquired from network node 90 in a message, such as message 150 shown in FIG. 9, to user equipment 26. As mentioned above, the set of thresholds included in the message 150 by access node 130 is configured for comparison by user equipment 26 with quality of service information obtained from each of at least two radio access technologies in conjunction with the user equipment making a selection, from radio resources of the at least two radio access technologies, of a radio resource(s) for transmission and/or reception of a V2X message of the V2X communication. The access node transmitter circuitry 136 of access node 130 serves, e.g., to transmit the message comprising the set of thresholds over a radio interface, e.g., interface Uu, to the user equipment 26.

Thus, in one of its example aspects, the technology disclosed herein provides configuration data into the NR_V2X_QoS process, e.g., to UE V2X controller 52, via a reuse and enhancement to the autonomous resource selection content of a particular information element, e.g., IE SL-CommTxPoolSensingConfig-14. In yet another aspect, the technology disclosed herein reuses the Rel-14 SIB21 to transport the SL-CommTxPoolSensingConfig-14 information element.

In an example implementation, an information element is used to carry information regarding UE autonomous resource selection. For present purpose, such information element is called “IE SL CommTxPoolSensingConfig-16”. In another of its example aspects, the technology disclosed herein refers to a system information block (SIB) that carries the new IE SL CommTxPoolSensingConfig-16 as “SIBx-NR-V2X”. One enhancement to CommTxPoolSensingConfig-16 is the inclusion of new configuration elements for defining a QoS threshold.

As understood from the foregoing and employed in the examples below, the QoS elements may be captured in the table BSM_QoS_Table, e.g., configured threshold table 80, and the thresholds are indicated by the table index(ices), e.g., BSM_QoS_Index_A and BSM_QoS_Index_B. Each entry in the BSM_QoS_Table may comprise data objects. The examples of FIG. 6B and FIG. 6B show each entry, e.g., each set of thresholds 82, as comprising three data objects. More data objects may be included, such as (unillustrated in FIG. 6B and FIG. 6C) a first data object which specifies the Resource Type, which can take a value of [GRB, non-GBR]. A second data object also unillustrated in FIG. 6B and FIG. 6C, is Scheduling priority, which can take a value in the range of [0.0 to 99.5]. A third data object may be Packet Delay Budget, which can take a value in the range of [0 to 1000 ms]. A fourth data object may be the Packet Error Rate, which can take a value in the range of [10⁻¹ to 10⁻⁹]. The BSM_QoS_Index_A and BSM_QoS_Index_B are indices that point into the BSM_QoS_Table, and indicates which entry of the BSM_QoS_Table is to be used by the NR_V2X_QoS process.

As mentioned above, the NR user equipment 26 may be pre-configured with the threshold table 80, and that the signaled threshold table 80 may take precedence over the pre-configuration. Moreover, the configured threshold table 80, and Index_A and Index_B may be sent to the UE as part of an RRC_Reconfiguration message, in which case the UE 26 will use that data instead of the data sent in the SIBx-NR-V2X message until UE receives a new SIBx-NR-V2X from a different gNB.

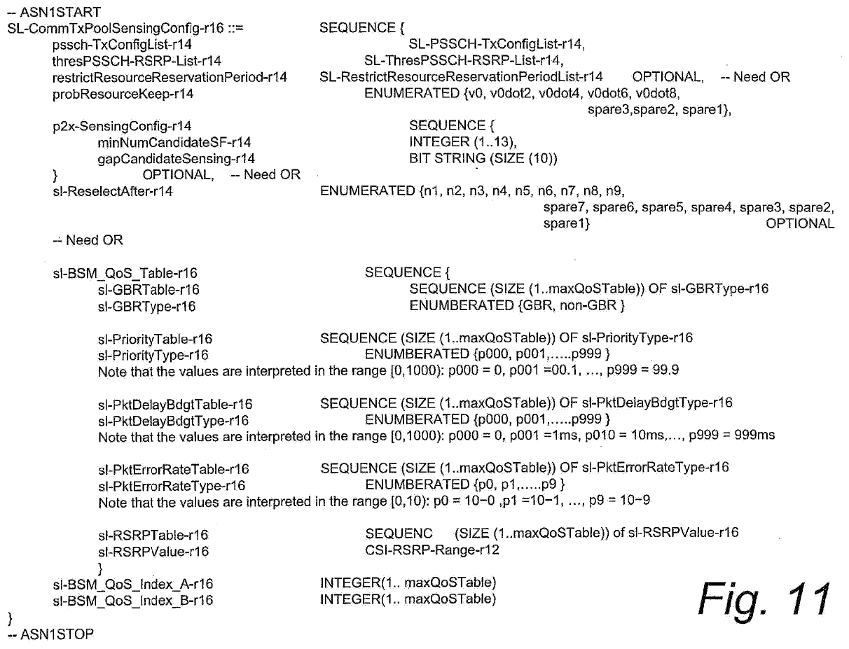

FIG. 11 shows an example, non-limiting illustration of an information element SL-CommTxPoolSensingConfig-r16, with the addition of BSM_QoS_Table and BSM_QoS_Index_A and BSM_QoS_Index_B.

As described above, the UE 26 may perform the sidelink communication by using LTE type resources (LTE resources), NR type resources (NR resources), or LTE and NR type resources (LTE and NR resources). For example, the UE may switch the resources used for the sidelink communication, based on the conditions (e.g., the conditions configured by the gNB.

It was mentioned above that the parameter generator 120 may generate an indication of resource pools from which the resource(s) to be used for the V2X message may be selected. Accordingly:
In case that LTE resources (e.g., LTE resource pools) are used, the UE may receive, based on a parameter (e.g., v2x-RxPool-LTE), the sidelink communication (e.g., the sidelink communication monitoring). In case that LIE resources (e.g., LTE resource pools) are used, the UE may transmit, based on a parameter (e.g., v2x-TxPool-LTE), the sidelink communications. For example, if the UE is configured to receive the sidelink communication, the UE may use the LIE resources based on the parameter (e.g., v2x-RxPool-LTE). Also, if UE is configured to transmit the sidelink communication, the UE may use the LIE resources based on the parameter (e.g., v2x-TxPool-LIE).
In case that NR resources (e.g., NR resource pools) are used, the UE may receive, based on a parameter (e.g., v2x-RxPool-NR), the sidelink communication (e.g., the sidelink communication monitoring). Also, in case that NR resources (e.g., NR resource pools) are used, the UE may transmit, based on a parameter (e.g., v2x-TxPool-NR), the sidelink communications. For example, if the UE is configured to receive the sidelink communication, the UE may use the NR resources based on the parameter (e.g., v2x-RxPool-NR). Also, if the UE is configured to transmit the sidelink communication, the UE may use the NR resources based on the parameter (e.g., v2x-TxPool-NR).
in case that LIE and/or NR resources (e.g., LIE resource pools and/or NR resource pools) are used, the UE may receive, based on a parameter (e.g., v2x-RxPool-LTE and/or v2x-RxPool-NR), the sidelink communication (e.g., the sidelink communication monitoring), as described above. Also, in case that LTE and/or NR resources (e.g., LIE resource pools and/or NR resource pools) are used, the LT may transmit, based on a parameter (e.g., v2x-TxPool-LTE, and/or v2x-TxPool-NR), the sidelink communications, as described above. For example, if the UE is configured to receive the sidelink communication, the LE may use LTE and/or NR resources based on the parameter v2x-RxPool-LTE, and/or v2x-RxPool-NR). Also, if the UE is configured to transmit the sidelink communication, the UE may use LTE and/or NR resources based on the parameter (e.g., v2x-TxPool-LTE, and/or v2x-TxPool-NR).

Thus, the parameters “v2x-TxPool-LTE”, and/or “v2x-TxPool-NR” may be used for indicating the resources by which the UE is allowed to transmit the sidelink communication. Also, the parameters “v2x-RxPool-LTE”, and/or “v2x-RxPool-NR” may be used for indicating the resources by which the UE is allowed to receive the sidelink communication. The maximum number of resource pools for “v2x-TxPool-LTE”, “v2x-TxPool-NR”, “v2x-RxPool-LTE”, and/or “v2x-RxPool-NR” may be independently defined (e.g., configured). Namely, the different maximum number of pools for LTE resources (e.g., transmission pools and/or reception pools) and/or NR resources (e.g., transmission pools and/or reception pools) may be defined. Also, LTE resources (e.g., transmission pools and/or reception pools) indicated by the parameters and NR resources (e.g., transmission pools and/or reception pools) indicated by the parameters may be overlapped.

As an example of the foregoing, SIB “SIBx-NR-V2X” may include the parameters for LTE resources (e.g., LTE resources (e.g., v2x-RxPool-LTE, v2x-TxPool-LTE)) used for the sidelink communication. Also, SIB “SIBx-NR-V2X” may include the parameters for NR resources (e.g., NR resources (e.g., v2x-RxPool-NR, v2x-TxPool-NR)) used for the sidelink communication.

In a case that the parameter(s) for NR resources (e.g., v2x-RxPool-NR, v2x-TxPool-NR) is configured, the gNB may further configure a parameter(s) used for the sidelink communication.

Other parameter(s) configured by the gNB may comprise: configuration for a block comprising, at least, Primary Sidelink Synchronization Signal (PSSS), Secondary Sidelink Synchronization Signal (SSSS), Physical Broadcast Channel (PBCH), and/or Demodulation reference signal (DM-RS) associated with the PBCH.

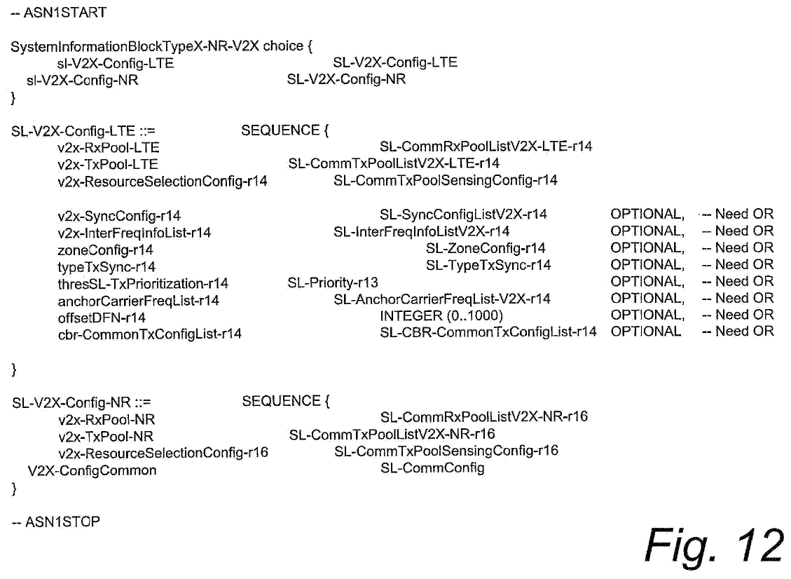

FIG. 12 shows an example, non-limiting illustration of a SIB “SIBx-NR-V2X”, e.g., a SystemInformationBlockTypeX-NR-V2X that comprises V2X sidelink communication configuration. The parameters “SL-CommRxPoolListV2X-LTE”, “SL-CommTxPoolListV2X-LTE”, “SL-CommRxPoolListV2X-NR”, “SL-CommTxPoolListV2X-NR”, utilized in FIG. 12 may each include, e.g.:
a parameter(s) used for identifying an identification for the resources (e.g., the resource pool(s)) for the sidelink transmission
a parameter(s) used for indicating a periodicity for the side link transmission
a parameter(s) used for indicating an offset value for the sidelink transmission
a parameter(s) used for indicating a position of the resources (e.g., the resource pool(s)) for the sidelink transmission
a parameter(s) used for indicating TDD configuration associated with the sidelink transmission

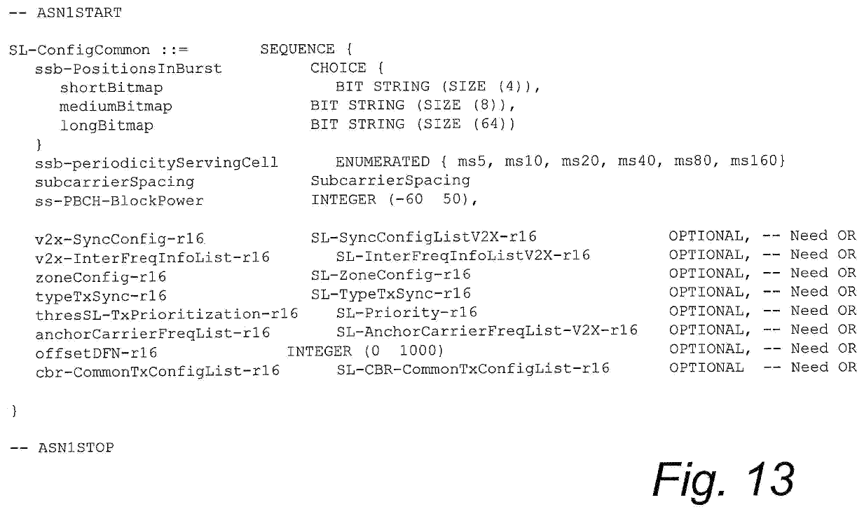

FIG. 13 shows as example, representative illustration of a “S L-CommConfig” information element. With reference to the listing of FIG. 13,
a parameter(s) “ssb-PositionsInBurst” may be used for indicating the time domain position(s) of the SSSB.
a parameter “shortBitmap” may be used for the sidelink transmission on sub 3 GHz (i.e., a frequency band(s) of sub 3 GHz).
a parameter “mediumBitmap” may be used for the sidelink transmission on 3-6 GHz (i.e., a frequency band(s) of 3-6 GHz).
a parameter “longBitmap” may be used for the sidelink transmission on above 6 GHz (i.e., a frequency band(s) of above 6 GHz).
a parameter(s) “ssb-periodicityServingCell” may be used for indicating periodicity of the SSSB.
a parameter(s) “subcarrierSpacing” may be used for indicating the SCS(s) (subcarrier spacing(s)) (e.g., the numerology) of the SSSB.
a parameter(s) “ss-PBCH-BlockPower” may be used for determining Tx power used for the SSSB transmission.

Table 2 provides a detailed description of a non-limiting, example algorithm or logic that may be implemented by V2X message resource selection procedure 70 in accordance with an example embodiment and mode.

TABLE 2
Upon receiving SystemInformationBlockTypeX-
NR-V2X, the UE shall:

1> if SystemInformationBlockTypex-NR-V2X message

includes only sl-V2X-Config-LTE:

2> not perform HARQ feedback (e.g., ACK and/or NACK

transmission)

2> if configured to receive V2X sidelink

communication:

3>use the resource pool indicated by

v2x-RxPool-LTE in SL-V2X-Config-LTE for V2X
sidelink communication monitoring;
2> if configured to transmit V2X sidelink

communication:

3>use the resource pool indicated by

v2x-TxPool-LTE in SL-V2X-Config-LTE for V2X
sidelink communication transmission;

1> if SystemInformationBlockTypex-NR-V2X message

includes only sl-V2X-Config-NR:

2> perform HARQ feedback (e.g., ACK and/or NACK

transmission)

2> if configured to receive V2X sidelink

communication:

3>use the resource pool indicated by

v2x-RxPool-NR in SL-V2X-Config-NR for V2X sidelink
communication monitoring;
2> if configured to transmit V2X sidelink

communication:

3>use the resource pool indicated by

v2x-TxPool-NR in SL-V2X-Config-NR for V2X sidelink
communication transmission;

1> if SystemInformationBlockTypex-NR-V2X message

includes both sl-V2X-Config-NR AND sl-V2X-Config-LTE:

2 if configured to receive V2X sidelink

communication:

3> if sl-V2X-Config-NR message includes

SL-CommTxPoolSensingConfig-r16

4> if SL-CommTxPoolSensingConfig-r16

message includes sl-BSM_QoS_Table-r16

5> use sl-BSM_QoS_Table-r16 from

SL-CommTxPoolSensingConfig-r16;
4> else

5> if the UEs default configuration

includes sl-BSM_QcS_Table-r16

6> use sl-BSM_QoS_Table-r16

from the UEs default configuration;
5> else

6> exit

4> if SL-CommTxPoolSensingConfig-r16

message does not includes
sl-BSM_QoS_Index_A-r16

5> exit;

4> if SL-CommTxPoolSensingConfig-r16

message does not includes
sl-BSM_QoS_Index_B-r16

5> use sl-BSM_QoS_Index_A-r16 as a

Single_Threshold configuration to select
resource pools
4> else

5> use sl-BSM_QoS_Index_A-r16 and

sl-BSM_QoS_Index_B-r16 as a
Multiple_Threshold configuration to
select resource pools

2> if configured to transmit V2X sidelink

communication:

3> if sl-V2X-Config-NR message includes

SL-CommTxPoolSensingConfig-r16

4> if SL-CommTxPoolSensingConfig-r16

message includes sl-BSM_QoS_Table-r16

5> use sl-BSM_QoS_Table-r16 from

SL-CommTxPoolSensingConfig-r16;
4> else

5> if the UEs default configuration

includes sl-BSM_QoS_Table-r16

6> use sl-BSM_QoS_Table-r16

from UEs default configuration;
5> else

6> exit

4> if SL-CommTxPoolSensingConfig-r16

message does not includes
sl-BSM_QoS_Index_A-r16

5> exit;

4> if SL-CommTxPoolSensingConfig-r16

message does not includes
sl-BSM_QoS_Index_B-r16

5> use sl-BSM_QoS_Index_A-r16 as a

Single_Threshold configuration to select
resource pools
4> else

5> use sl-BSM_QoS_Index_A-r16 and

sl-BSM_QoS_Index_B-r16 as a
Multiple_Threshold configuration to
select resource pools

2> if Single_Threshold configuration is used to select

resource pools:
3> perform HARQ feedback (e.g., ACK and/or NACK
transmission)
3> if S_Measure <
sl-BSM_QoS_Table-r16[sl-BSM_QoS_Index_A-r16].S_Measur
e and

3> Packet_Delay >

sl-BSM_QoS_Table-r16[sl-BSM_QoS_Index_A-r16].Packet
_Delay and

3> Packet_Error >

sl-BSM_QoS_Table-r16[sl-BSM_QoS_Index_A-r16].Packet
_Error
4> Set PC5 to use Both LTE and NR resource for Tx of
BSM message

3> else:

4> if S_Measure >=
sl-BSM_QoS_Table-r16[sl-BSM_QoS_Index_A-r16].S_Meas
ure and
4> Packet_Delay >

sl-BSM_QoS_Table-r16[sl-BSM_QoS_Index_A-r16].Pack
et_Delay and

4> Packet_Error >

sl-BSM_QoS_Table-r16[sl-BSM_QoS_Index_A-r16].Pack
et_Error
5> Set PC5 to use LTE resource for Tx of BSM message

4> else:

5> Set PC5 to use NR resource for Tx of BSM message

2> if Multiple_Threshold configuration is used to select

resource pools:
3> if S_Measure <
sl-BSM_QoS_Table-r16[sl-BSM_QoS_Index_A-r16].S_Measur
e and
3> Packet_Delay >

sl-BSM_QoS_Table-r16[sl-BSM_QoS_Index_A-r16].Packet
_Delay and

3> Packet_Error >

sl-BSM_QoS_Table-r16[sl-BSM_QoS_Index_A-r16].Packet
_Error

4> Set PC5 to use Both LTE and NR resource for Tx of
BSM message
4> perform HARQ feedback (e.g., ACK and/or NACK
transmission)

3> else:

4> if S_Measure >=
sl-BSM_QoS_Table-r16[sl-BSM_QoS_Index_A-r16].S_Meas
ure and
4> Packet_Delay >

sl-BSM_QoS_Table-r16[sl-BSM_QoS_Index_A-r16].Pack
et_Delay and

4> Packet_Error >

sl-BSM_QoS_Table-r16[sl-BSM_QoS_Index_A-r16].Pack
et_Error
5> Set PC5 to use LTE resource for Tx of BSM message
5> NOT perform HARQ feedback (e.g., ACK and/or NACK

transmission)

4> else:

5> if S_Measure <
sl-BSM_QoS_Table-r16[sl-BSM_QoS_Index_A-r16].S_Me
asure and

5> Packet_Delay <=

sl-BSM_QoS_Table-r16[sl-BSM_QoS_Index_A-r16].Pa
cket_Delay and

5> Packet_Error <=

sl-BSM_QoS_Table-r16[sl-BSM_QoS_Index_A-r16].Pa
cket_Error
6> Set PC5 to use NR resource for Tx of BSM message
6> perform HARQ feedback (e.g., ACK and/or NACK

transmission)

5> else:

6> if S_Measure <

sl-BSM_QoS_Table-r16[sl-BSM_QoS_Index_B-r16].
S_Measure

7> Set PC5 to use LTE resource for Tx of BSM

message

7> NOT perform HARQ feedback (e.g., ACK and/or

NACK transmission)

6> else:

7> Set PC5 to use NR resource for Tx of BSM

message

7> perform HARQ feedback (e.g., ACK and/or NACK

transmission)

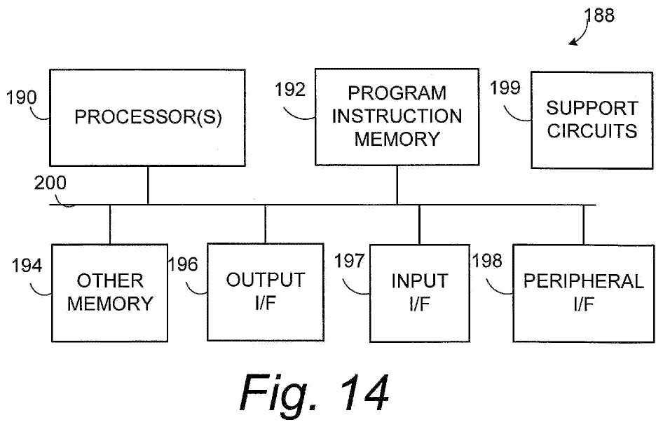

Certain units and functionalities of wireless terminal 20 may be implemented by electronic machinery. For example, terminal electronic machinery 188 is shown for wireless terminal 26 in FIG. 4. The network node 90 and access node 130 similarly may employ electronic machinery. FIG. 14 shows an example of such electronic machinery as comprising one or more processors 190, program instruction memory 192; other memory 194 (e.g., RAM, cache, etc.); input/output interfaces 196 and 197, peripheral interfaces 198; support circuits 199; and busses 200 for communication between the aforementioned units. The processor(s) 190 may comprise the processor circuitries described herein, for example, the UE processor 50 of user equipment 26, the node processor circuitry 92 of network node 90, and/or the access node processor circuitry 132 of access node 130.

The memory 194, or computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory 60 shown in FIG. 4. The support circuits 199 are coupled to the processors 190 for supporting the processor in a conventional manner. These circuits include cache, power supplies, clock circuits, input/output circuitry and subsystems, and the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

Moreover, each functional block or various features of the user equipment 26 used in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Among its various embodiments and modes, the technology disclosed herein includes one or more of the following features and/or benefits:
A Rel-16 NR UE process that uses one or multiple thresholds, configured by the network.
A Rel-16 NR UE process that uses data from a table of QoS metrics, configured by the network or pre-configured at time of mfg.
A Rel-16 NR UE process that uses Error Rate and Delay Rate (provided by the NR Sidelink HARQ process) and RSRP (provided by the S-measure on the sidelink channel).
A Rel-16 NR UE process that determines if NR or LTE or both NR and LTE resources are used to transport a BSM, based on the thresholds and QoS configuration data
The QoS configuration data is dynamically determined by a 5G Core network for transport to the UE.
The QoS configuration data is pre-provisioned in the UE at time of manufacture.
The QoS configuration data is transported to the UE by the 5G RAN via a broadcast message (i.e. a SIB)
The QoS configuration data is transported to the UE by be 5G RAN via a
unicast a reconfiguration message.)
The broadcast QoS configuration data has priory over pre-provisioned data.
The unicast QoS configuration data has priory over broadcast data, until a new broadcast QoS configuration is received from a new macro cell
The QoS configuration data is carried in a revised IE that is either broadcasted by the 5G network via a SIB, or is unicasted via a RRC reconfiguration message.

One or more features of the example embodiments and modes described herein may be used in conjunction with one or more other features, in any combination.

The following definitions and/or explanations apply to the corresponding terms as utilized herein:
s-Measure: E-UTRAN provides this measurement configuration information element carried in the measConfig. The measConfig is transported to the UE via RRCConnectionReconfiguration or RRCCorrectionResume message. The s-Measure defines when the UE is required to perform measurements. The UE is however allowed to perform measurements also when the RSRP exceeds s-Measure. When the received measConfig includes the s-Measure, the UE will set the parameter s-Measure within VarMeasConfig to the lowest value of the RSRP ranges indicated by the received value of s-Measure.
Quality of Service (QoS): The description or measurement of the overall performance of a service, such as a telephony or computer network or a cloud computing service, particularly the performance seen by the users of the network. To quantitatively measure quality of service, several related aspects of the network service are often considered, such as packet loss, bit rate, throughput, transmission delay, availability, jitter, etc.
Guaranteed Bit Rate (GBR): This parameter is used to describe a LTE bearer (PC5 in this case), and indicates the bandwidth (bit rate) to be guaranteed by the channel. It is not applied to a non-GBR bearer with no guaranteed bandwidth.
Scheduling priority: This is a value that provides the scheduler to differentiate between different bearers. Higher-priority packets are transferred before lower-priority packets.
Packet Delay Budget: The packet delay budget defines an upper boundary for the packet delay between the UE's (using PC5 in this case).
Packet Error Rate: Is the percentage of packets that are lost during periods when the transport channel (PC5 in this case) is not congested.

The technology disclosed herein thus comprises and compasses the following non-exhaustive example embodiments and modes:

Example Embodiment 1: A user equipment which participates in vehicle-to-anything (V2X) communications, comprising:
processor circuitry configured to autonomously make a selection, from radio resources of at least two radio access technologies, of a radio resource(s) for transmission and/or reception of a V2X message of the V2X communication;
a transmitter and/or receiver configured to use the selected radio resource(s) for the transmission and/or reception of the V2X message.

Example Embodiment 2: The apparatus of Example Embodiment 1, wherein the processor circuitry is configured to make the selection of the radio resource(s) for transmission and/or reception of the V2X message of the V2X communication from either:
an LTE radio resource(s);
a New Radio (NR) 5G radio resource(s);
both the LTE radio resource(s) and the NR 5G radio resources.

Example Embodiment 3: The apparatus of Example Embodiment 1, Wherein the processor circuitry is configured to make the selection by making a comparison of:
quality of service information for a V2X-utilized channel obtained from each of the two radio access technologies; and
a set of thresholds comprising a respective threshold for the quality of service information obtained from each of the two radio access technologies.

Example Embodiment 4: The apparatus of Example Embodiment 3, further comprising memory circuitry, the memory circuitry comprising a configured table of plural sets of thresholds.

Example Embodiment 5: The apparatus of Example Embodiment 4, wherein the at least one particular set(s) of thresholds to be used for the comparison is preconfigured at the user equipment.

Example Embodiment 6: The apparatus of Example Embodiment 4, wherein the at least one particular set(s) of thresholds to be used for the comparison by the processor circuitry is configured by a network.

Example Embodiment 7: The apparatus of Example Embodiment 6, wherein the processor circuitry is configured to determine the at least one particular set(s) of thresholds of the configured table to be used for the comparison based on a corresponding table index(ices) received by the user equipment from the network.

Example Embodiment 8: The apparatus of Example Embodiment 7, wherein the processor circuitry is configured to determine two sets of thresholds to be used for the comparison based on two corresponding table indices received by the user equipment from the network.

Example Embodiment 9: The apparatus of Example Embodiment 7, wherein the processor circuitry is configured to determine the configured table and the corresponding table index(ices) from a unicast message.

Example Embodiment 10: The apparatus of Example Embodiment 9, wherein the processor circuitry is configured to prioritize a configured table obtained from the unicast message over a configured table obtained from an earlier broadcast message until a new configured table is later obtained from a broadcast message from a new macrocell.

Example Embodiment 11: The apparatus of Example Embodiment 9, wherein the processor circuitry is configured to determine the configured table and the corresponding table index(ices) from a RRC_Reconfiguration message.

Example Embodiment 12: The apparatus of Example Embodiment 6, wherein the processor circuitry is configured to determine the configured table and the corresponding table index(ices) from a broadcast message.

Example Embodiment 13: The apparatus of Example Embodiment 12, wherein the processor circuitry is configured to determine the configured table and the corresponding table index(ices) from a system information block (SIB).

Example Embodiment 14: The apparatus of Example Embodiment 12, wherein the processor circuitry is configured to prioritize a configured table obtained from the broadcast message over a configured table that was preconfigured at the user equipment.

Example Embodiment 15: The apparatus of Example Embodiment 13, wherein the processor circuitry is further configured to determine, from the system information block (SIB), an indication of pools of radio resources from which the radio resource(s) for transmission and/or reception of the V2X message of the V2X communication may be selected.

Example Embodiment 16: The apparatus of Example Embodiment 3, wherein for a first radio access technology the quality of service information comprises error rate and delay rate for the V2X-utilized channel and for a second radio access technology the quality of service information comprises a received signal measurement for the V2X-utilized channel.

Example Embodiment 17: The apparatus of Example Embodiment 16, wherein the first radio access technology is New Radio (NR) 5G, wherein the error rate and delay rate for the first radio access technology are reported by a HARQ process, wherein the second radio access technology is Long Term Evolution (LTE), and wherein the V2X-utilized channel is a Sidelink PC5 channel.

Example Embodiment 18: A method in a user equipment which participates in vehicle-to-anything (V2X) communications, comprising:
using processor circuitry to autonomously make a selection, from radio resources of at least two radio access technologies, of a radio resource(s) for transmission and/or reception of a V2X message of the V2X communication;
using the selected radio resource(s) for the transmission and/or reception of the V2X message.

Example Embodiment 19: The method of Example Embodiment 18, further comprising making the selection of the radio resources) for transmission and/or reception of the V2X message of the V2X communication from either:
an LTE radio resource(s);
a New Radio (NR) 5G radio resource(s);
both the LTE radio resource(s) and the NR 5G radio resources.

Example Embodiment 20: The method of Example Embodiment 18, further comprising making the selection by making a comparison of
quality of service information for a V2X-utilized channel obtained from each of the two radio access technologies; and
a set of thresholds comprising a respective threshold for the quality of service information obtained from each of the two radio access technologies.

Example Embodiment 21: The method of Example Embodiment 20, wherein the at least one particular set(s) of thresholds to be used for the comparison is preconfigured at the user equipment.

Example Embodiment 22: The method of Example Embodiment 21, wherein the at least one particular set(s) of thresholds to be used for the comparison by the processor circuitry is configured by a network.

Example Embodiment 23: The method of Example Embodiment 21, further comprising determining, from a configured table, the at least one particular set(s) of thresholds to be used for the comparison based on a corresponding table index(ices) received by the user equipment from the network.

Example Embodiment 24: The method of Example Embodiment 23, further comprising determining, from a configured table, two sets of thresholds to be used for the comparison based on two corresponding table indices received by the user equipment from the network.

Example Embodiment 25: The method of Example Embodiment 23, further comprising determining the configured table and the corresponding table index(ices) from a unicast message.

Example Embodiment 26: The method of Example Embodiment 25, further comprising prioritizing a configured table obtained from the unicast message over a configured table obtained from an earlier broadcast message until a new configured table is later obtained from a broadcast message from a new macrocell.

Example Embodiment 27: The method of Example Embodiment 25, further comprising determining the configured table and the corresponding table index(ices) from a RRC_Reconfiguration message.

Example Embodiment 28: The method of Example Embodiment 21, further comprising determining the configured table and the corresponding table index(ices) from a broadcast message.

Example Embodiment 29: The method of Example Embodiment 28, further comprising determining the configured table and the corresponding table index(ices) from a system information block (SIB).

Example Embodiment 30: The method of Example Embodiment 28, further comprising prioritizing a configured table obtained from the broadcast message over a configured table that was preconfigured at the user equipment.

Example Embodiment 31: The method of Example Embodiment 29, further comprising determining, from the system information block (SIB), an indication of pools of radio resources from which the radio resource(s) for transmission and/or reception of the V2X message of the V2X communication may be selected.

Example Embodiment 32: The method of Example Embodiment 20, wherein for a first radio access technology the quality of service information comprises error rate and delay rate for the V2X-utilized channel and for a second radio access technology the quality of service information comprises a received signal measurement for the V2X-utilized channel.

Example Embodiment 33: The method of Example Embodiment 32, wherein the first radio access technology is New Radio (NR) 5G, wherein the error rate and delay rate for the first radio access technology are obtained by a HARQ process, wherein the second radio access technology is Long Term Evolution (LTE), and wherein the V2X-utilized channel is a Sidelink PC5 channel.

Example Embodiment 34: A node of a core network comprising:
processor circuitry configured to generate a set of thresholds, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication;
interface circuitry configured to transmit the set of thresholds ultimately to a node of a radio access network that is in radio communication with the user equipment.

Example Embodiment 35: The node of Example Embodiment 34, wherein the processor circuitry is configured to generate the set of thresholds to include:
for a first radio access technology, an error rate threshold and a delay rate threshold for a V2X-utilized channel; and
fir a second radio access technology, a received signal measurement for the V2X-utilized channel.

Example Embodiment 36: The node of Example Embodiment 35, wherein the first radio access technology is New Radio (NR) 5G, wherein the error rate and delay rate for the first radio access technology are reported by a HARQ process, wherein the second radio access technology is Long Term Evolution (LTE), and wherein the V2X-utilized channel is a Sidelink PC5 channel.

Example Embodiment 37: The node of Example Embodiment 34, wherein the processor circuitry is configured to generate a table comprising plural sets of thresholds, the table comprising plural sets of thresholds being configured to use by the user equipment of at least one table index, the at least one table index being configured to enable the user equipment to determine at least one particular set(s) of thresholds of the configured table to be used for the comparison.

Example Embodiment 38: A method in a node of a core network, the method comprising:
using processor circuitry to generate a set of thresholds, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication;
transmitting the set of thresholds ultimately to a node of a radio access network that is in radio communication with the user equipment.

Example Embodiment 39: The method of Example Embodiment 38, further comprising generating the set of thresholds to include:
for a first radio access technology, an error rate threshold and a delay rate threshold for a V2X-utilized channel; and
for a second radio access technology, a received signal measurement for the V2X-utilized channel.

Example Embodiment 40: The method of Example Embodiment 39, wherein the first radio access technology is New Radio (NR) 5G, wherein the error rate and delay rate for the first radio access technology are reported by a HARQ process, wherein the second radio access technology is Long Term Evolution (LTE), and wherein the V2X-utilized channel is a Sidelink PC5 channel.

Example Embodiment 41: The method of Example Embodiment 38, further comprising generating a table comprising plural sets of thresholds, the table comprising plural sets of thresholds being configured to use by the user equipment of at least one table index, the at least one table index being configured to enable the user equipment to determine at least one particular set(s) of thresholds of the configured table to be used for the comparison.

Example Embodiment 42: A node of a radio access network comprising:
processor circuitry configured to include a set of thresholds in a message, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication;
transmitter circuitry configured to transmit the message comprising the set of thresholds over a radio interface to the user equipment.

Example Embodiment 43: The node of Example Embodiment 42, wherein the processor circuitry is further configured:
to include a table comprising plural sets of thresholds in the message,
to generate at least one table index, the at least one table index being configured to enable the user equipment to determine at least one particular set(s) of thresholds of the configured table to be used for the comparison.

Example Embodiment 44: The apparatus of Example Embodiment 43, wherein the processor circuitry is configured to generate two indices to enable the user equipment to determine two sets of thresholds to be used for the comparison.

Example Embodiment 45: The apparatus of Example Embodiment 43, wherein the processor circuitry is configured to include the configured table and the at least one table index in a unicast message.

Example Embodiment 46: The apparatus of Example Embodiment 45, wherein the processor circuitry is configured to include the configured table and the table index in a RRC_Reconfiguration message.

Example Embodiment 47: The apparatus of Example Embodiment 43, wherein the processor circuitry is configured to include the configured table and the at least one table index in a broadcast message.

Example Embodiment 48: The apparatus of Example Embodiment 47, wherein the processor circuitry is configured to include the configured table and the at least one table index in a system information block (SIB).

Example Embodiment 49: The node of Example Embodiment 42, wherein the set of thresholds includes:
for a first radio access technology, an error rate threshold and a delay rate threshold for a V2X-utilized channel; and
for a second radio access technology, a received signal measurement for the V2X-utilized channel.

Example Embodiment 50: A method in node of a radio access network, the method comprising:
using processor circuitry to include a set of thresholds in a message, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication;
transmitting the message comprising the set of thresholds over a radio interface to the user equipment.

Example Embodiment 51: The method of Example Embodiment 50, wherein the first radio access technology is New Radio (NR) 5G, wherein the error rate and delay rate for the first radio access technology are reported by a HARQ process, wherein the second radio access technology is Long Term Evolution (LTE), and wherein the V2X-utilized channel is a Sidelink PC5 channel.

It will be appreciated that the technology disclosed herein is directed to solving radio communications-centric issues and is necessarily rooted in computer technology and overcomes problems specifically arising in radio communications. Moreover, the technology disclosed herein improves basic function of a wireless terminal, e.g., a user equipment, a network node, and a base station, so that, for example, operation of these entities may occur more effectively by prudent use of radio resources. For example, the technology disclosed herein enables the user equipment 26 to make a judicious use of radio resources for a V2X message, particularly in view of quality of service and other concerns/issues.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

### SUMMARY

In one example, a user equipment which participates in vehicle-to-anything (V2X) communications, comprising: processor circuitry configured to autonomously make a selection, from radio resources of at least two radio access technologies, of a radio resource(s) for transmission and/or reception of a V2X message of the V2X communication; a transmitter and/or receiver configured to use the selected radio resource(s) for the transmission and/or reception of the V2X message.

In one example, the apparatus, wherein the processor circuitry is configured to make the selection of the radio resource(s) for transmission and/or reception of the V2X message of the V2X communication from either: an LTE radio resource(s); a New Radio (NR) 5G radio resource(s); both the LTE radio resource(s) and the NR 5G radio resources.

In one example, the apparatus, wherein the processor circuitry is configured to make the selection by making a comparison of: quality of service information for a V2X-utilized channel obtained from each of the two radio access technologies; and a set of thresholds comprising a respective threshold for the quality of service information obtained from each of the two radio access technologies.

In one example, the apparatus, further comprising memory circuitry, the memory circuitry comprising a configured table of plural sets of thresholds.

In one example, the apparatus, wherein the at least one particular set(s) of thresholds to be used for the comparison is preconfigured at the user equipment.

In one example, the apparatus, wherein the at least one particular set(s) of thresholds to be used for the comparison by the processor circuitry is configured by a network.

In one example, the apparatus, wherein the processor circuitry is configured to determine the at least one particular set(s) of thresholds of the configured table to be used for the comparison based on a corresponding table index(ices) received by the user equipment from the network.

In one example, the apparatus, wherein the processor circuitry is configured to determine two sets of thresholds to be used for the comparison based on two corresponding table indices received by the user equipment from the network.

In one example, the apparatus, wherein the processor circuitry is configured to determine the configured table and the corresponding table index(ices) from a unicast message.

In one example, the apparatus, wherein the processor circuitry is configured to prioritize a configured table obtained from the unicast message over a configured table obtained from an earlier broadcast message until a new configured table is later obtained from a broadcast message from a new macrocell.

In one example, the apparatus, wherein the processor circuitry is configured to determine the configured table and the corresponding table index(ices) from a RRC_Reconfiguration message.

In one example, the apparatus, wherein the processor circuitry is configured to determine the configured table and the corresponding table index(ices) from a broadcast message.

In one example, the apparatus, wherein the processor circuitry is configured to determine the configured table and the corresponding table index(ices) from a system information block (SIB).

In one example, the apparatus, wherein the processor circuitry is configured to prioritize a configured table obtained from the broadcast message over a configured table that was preconfigured at the user equipment.

In one example, the apparatus, wherein the processor circuitry is further configured to determine, from the system information block (SIB), an indication of pools of radio resources from which the radio resource(s) for transmission and/or reception of the V2X message of the V2X communication may be selected.

In one example, the apparatus, wherein for a first radio access technology the quality of service information comprises error rate and delay rate for the V2X-utilized channel and for a second radio access technology the quality of service information comprises a received signal measurement for the V2X-utilized channel.

In one example, the apparatus, wherein the first radio access technology is New Radio (NR) 5G, wherein the error rate and delay rate for the first radio access technology are reported by a HARQ process, wherein the second radio access technology is Long Term Evolution (LTE), and wherein the V2X-utilized channel is a Sidelink PC5 channel.

In one example, a method in a user equipment which participates in vehicle-to-anything (V2X) communications, comprising: using processor circuitry to autonomously make a selection, from radio resources of at least two radio access technologies, of a radio resource(s) for transmission and/or reception of a V2X message of the V2X communication; using the selected radio resource(s) for the transmission and/or reception of the V2X message.

In one example, the method, further comprising making the selection of the radio resource(s) for transmission and/or reception of the V2X message of the V2X communication from either: an LTE radio resource(s); a New Radio (NR) 5G radio resource(s); both the LTE radio resource(s) and the NR 5G radio resources.

In one example, the method, further comprising making the selection by making a comparison of: quality of service information for a V2X-utilized channel obtained from each of the two radio access technologies; and a set of thresholds comprising a respective threshold for the quality of service information obtained from each of the two radio access technologies.

In one example, the method, wherein the at least one particular set(s) of thresholds to be used for the comparison is preconfigured at the user equipment.

In one example, the method, wherein the at least one particular set(s) of thresholds to be used for the comparison by the processor circuitry is configured by a network.

In one example, the method, further comprising determining, from a configured table, the at least one particular set(s) of thresholds to be used for the comparison based on a corresponding table index(ices) received by the user equipment from the network.

In one example, the method, further comprising determining, from a configured table, two sets of thresholds to be used for the comparison based on two corresponding table indices received by the user equipment from the network.

In one example, the method, further comprising determining the configured table and the corresponding table index(ices) from a unicast message.

In one example, the method, further comprising prioritizing a configured table obtained from the unicast message over a configured table obtained from an earlier broadcast message until a new configured table is later obtained from a broadcast message from a new macrocell.

In one example, the method, further comprising determining the configured table and the corresponding table index(ices) from a RRC_Reconfiguration message.

In one example, the method, further comprising determining the configured table and the corresponding table index(ices) from a broadcast message.

In one example, the method, further comprising determining the configured table and the corresponding table index(ices) from a system information block (SIB).

In one example, the method, further comprising prioritizing a configured table obtained from the broadcast message over a configured table that was preconfigured at the user equipment.

In one example, the method, further comprising determining, from the system information block (SIB), an indication of pools of radio resources from which the radio resource(s) for transmission and/or reception of the V2X message of the V2X communication may be selected.

In one example, the method, wherein for a first radio access technology the quality of service information comprises error rate and delay rate for the V2X-utilized channel and for a second radio access technology the quality of service information comprises a received signal measurement for the V2X-utilized channel.

In one example, the method, wherein the first radio access technology is New Radio (NR) 5G, wherein the error rate and delay rate for the first radio access technology are obtained by a HARQ process, wherein the second radio access technology is Long Term Evolution (LTE), and wherein the V2X-utilized channel is a Sidelink PC5 channel.

In one example, a node of a core network comprising: processor circuitry configured to generate a set of thresholds, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication; interface circuitry configured to transmit the set of thresholds ultimately to a node of a radio access network that is in radio communication with the user equipment.

In one example, the node, wherein the processor circuitry is configured to generate the set of thresholds to include: for a first radio access technology, an error rate threshold and a delay rate threshold for a V2X-utilized channel; and for a second radio access technology, a received signal measurement for the V2X-utilized channel.

In one example, the node, wherein the first radio access technology is New Radio (NR) 5G, wherein the error rate and delay rate for the first radio access technology are reported by a HARQ process, wherein the second radio access technology is Long Term Evolution (LTE), and wherein the V2X-utilized channel is a Sidelink PC5 channel.

In one example, the node, wherein the processor circuitry is configured to generate a table comprising plural sets of thresholds, the table comprising plural sets of thresholds being configured to use by the user equipment of at least one table index, the at least one table index being configured to enable the user equipment to determine at least one particular set(s) of thresholds of the configured table to be used for the comparison.

In one example, a method in a node of a core network, the method comprising: using processor circuitry to generate a set of thresholds, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication; transmitting the set of thresholds ultimately to a node of a radio access network that is in radio communication with the user equipment.

In one example, the method, further comprising generating the set of thresholds to include: for a first radio access technology, an error rate threshold and a delay rate threshold for a V2X-utilized channel; and for a second radio access technology, a received signal measurement for the V2X-utilized channel.

In one example, the method, wherein the first radio access technology is New Radio (NR) 5G, wherein the error rate and delay rate for the first radio access technology are reported by a HARQ process, wherein the second radio access technology is Long Term Evolution (LTE), and wherein the V2X-utilized channel is a Sidelink PC5 channel.

In one example, the method, further comprising generating a table comprising plural sets of thresholds, the table comprising plural sets of thresholds being configured to use by the user equipment of at least one table index, the at least one table index being configured to enable the user equipment to determine at least one particular set(s) of thresholds of the configured table to be used for the comparison.

In one example, a node of a radio access network comprising: processor circuitry configured to include a set of thresholds in a message, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication; transmitter circuitry configured to transmit the message comprising the set of thresholds over a radio interface to the user equipment.

In one example, the node, wherein the processor circuitry is further configured: to include a table comprising plural sets of thresholds in the message, to generate at least one table index, the at least one table index being configured to enable the user equipment to determine at least one particular set(s) of thresholds of the configured table to be used for the comparison.

In one example, the apparatus, wherein the processor circuitry is configured to generate two indices to enable the user equipment to determine two sets of thresholds to be used for the comparison.

In one example, the apparatus, wherein the processor circuitry is configured to include the configured table and the at least one table index in a unicast message.

In one example, the apparatus, wherein the processor circuitry is configured to include the configured table and the table index in a RRC_Reconfiguration message.

In one example, the apparatus, wherein the processor circuitry is configured to include the configured table and the at least one table index in a broadcast message.

In one example, the apparatus, wherein the processor circuitry is configured to include the configured table and the at least one table index in a system information block (SIB).

In one example, the node, wherein the set of thresholds includes: for a first radio access technology, an error rate threshold and a delay rate threshold for a V2X-utilized channel; and for a second radio access technology, a received signal measurement for the V2X-utilized channel.

In one example, a method in node of a radio access network, the method comprising: using processor circuitry to include a set of thresholds in a message, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication; transmitting the message comprising the set of thresholds over a radio interface to the user equipment.

In one example, the method, wherein the first radio access technology is New Radio (NR) 5G, wherein the error rate and delay rate for the first radio access technology are reported by a HARQ process, wherein the second radio access technology is Long Term Evolution (LTE), and wherein the V2X-utilized channel is a Sidelink PC5 channel.

In one example, a user equipment which participates in vehicle-to-anything (V2X) communications, comprising: processor circuitry configured to autonomously make a selection, from radio resources of at least two radio access technologies, of a radio resource(s) for transmission and/or reception of a V2X message of the V2X communication; a transmitter and/or receiver configured to use the selected radio resource(s) for the transmission and/or reception of the V2X message.

In one example, the apparatus, wherein the processor circuitry is configured to make the selection of the radio resource(s) for transmission and/or reception of the V2X message of the V2X communication from either: an LTE radio resource(s); a New Radio (NR) 5G radio resource(s); both the LTE radio resource(s) and the NR 5G radio resources.

In one example, the apparatus, wherein the processor circuitry is configured to make the selection by making a comparison of: quality of service information for a V2X-utilized channel obtained from each of the two radio access technologies; and a set of thresholds comprising a respective threshold for the quality of service information obtained from each of the two radio access technologies.

In one example, the apparatus, further comprising memory circuitry, the memory circuitry comprising a configured table of plural sets of thresholds.

In one example, a method in a user equipment which participates in vehicle-to-anything (V2X) communications, comprising: using processor circuitry to autonomously make a selection, from radio resources of at least two radio access technologies, of a radio resource(s) for transmission and/or reception of a V2X message of the V2X communication; using the selected radio resource(s) for the transmission and/or reception of the V2X message.

In one example, the method, further comprising making the selection of the radio resource(s) for transmission and/or reception of the V2X message of the V2X communication from either: an LTE radio resource(s); a New Radio (NR) 5G radio resource(s); both the LTE radio resource(s) and the NR 5G radio resources.

In one example, the method, further comprising making the selection by making a comparison of: quality of service information for a V2X-utilized channel obtained from each of the two radio access technologies; and a set of thresholds comprising a respective threshold for the quality of service information obtained from each of the two radio access technologies.

In one example, the method, wherein the at least one particular set(s) of thresholds to be used for the comparison is preconfigured at the user equipment.

In one example, a node of a core network comprising: processor circuitry configured to generate a set of thresholds, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication; interface circuitry configured to transmit the set of thresholds ultimately to a node of a radio access network that is in radio communication with the user equipment.

In one example, the node, wherein the processor circuitry is configured to generate the set of thresholds to include: for a first radio access technology, an error rate threshold and a delay rate threshold for a V2X-utilized channel; and for a second radio access technology, a received signal measurement for the V2X-utilized channel.

In one example, a method in a node of a core network, the method comprising: using processor circuitry to generate a set of thresholds, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication; transmitting the set of thresholds ultimately to a node of a radio access network that is in radio communication with the user equipment.

In one example, the method, further comprising generating the set of thresholds to include: for a first radio access technology, an error rate threshold and a delay rate threshold for a V2X-utilized channel; and for a second radio access technology, a received signal measurement for the V2X-utilized channel.

In one example, a node of a radio access network comprising: processor circuitry configured to include a set of thresholds in a message, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication; transmitter circuitry configured to transmit the message comprising the set of thresholds over a radio interface to the user equipment.

In one example, the node, wherein the processor circuitry is further configured: to include a table comprising plural sets of thresholds in the message, to generate at least one table index, the at least one table index being configured to enable the user equipment to determine at least one particular set(s) of thresholds of the configured table to be used for the comparison.

In one example, a method in node of a radio access network, the method comprising: using processor circuitry to include a set of thresholds in a message, the set of thresholds being configured for comparison by a user equipment with quality of service information obtained from each of at least two radio access technologies in conjunction with the user equipment making a selection, from radio resources of the at least two radio access technologies, of a radio resource(s) for transmission and/or reception of a V2X message of the V2X communication; transmitting the message comprising the set of thresholds over a radio interface to the user equipment.

In one example, the method, wherein the first radio access technology is New Radio (NR) 5G, wherein the error rate and delay rate for the first radio access technology are reported by a HARQ process, wherein the second radio access technology is Long Term Evolution (LTE), and wherein the V2X-utilized channel is a Sidelink PC5 channel.

1. A user equipment (UE) which participates in vehicle-to-anything (V2X) communications, the UE comprising:
processor circuitry configured to autonomously make a selection, from radio resources of at least two radio access technologies, of at least one radio resource;
at least a transmitter or receiver configured to use the selected at least one radio resource for transmission or reception of a V2X message.

2. The UE of claim 1, wherein the processor circuitry is further configured to make the selection of the at least one radio resource from at least one of an LTE radio resource and a New Radio (NR) 5G radio resource.

3. The UE of claim 1, wherein the processor circuitry is further configured to make the selection by comparing quality-of-service information for a V2X-utilized channel obtained from each of the at least two radio access technologies to a set of thresholds comprising a corresponding threshold for the quality-of-service information obtained from each of the at least two radio access technologies.

4. The UE of claim 3, further comprising memory circuitry storing a table of a plurality of sets of thresholds.

5. A method in a user equipment (UE) which participates in vehicle-to-anything (V2X) communications, the method comprising:
autonomously selecting, from radio resources of at least two radio access technologies, at least one radio resource;
using the selected at least one radio resource for transmission or reception of a V2X message.

6. The method of claim 5, wherein the selection of the at least one radio resource is from at least one of an LTE radio resource and a New Radio (NR) 5G radio resource.

7. The method of claim 5, wherein the selection comprising comparing quality-of-service information for a V2X-utilized channel obtained from each of the at least two radio access technologies to a set of thresholds comprising a corresponding threshold for the quality of service information obtained from each of the at least two radio access technologies.

8. The method of claim 7, wherein the set of thresholds is stored at the user equipment.

9-12. (canceled)

13. A node of a radio access network, the node comprising:
processor circuitry configured to include a set of thresholds in a message, the set of thresholds for comparison by a user equipment with quality-of-service information obtained from each of at least two radio access technologies;
transmitter circuitry configured to transmit the message comprising the set of thresholds over a radio interface to the user equipment.

14. The node of claim 13, wherein the processor circuitry is further configured to:
include a table comprising a plurality of sets of thresholds in the message; and
generate at least one table index configured for determining at least one set of thresholds of the configured table for the comparison.

15-16. (canceled)
